(19) United States
(12) Patent Application Publication
(10) Pub. No.: US 2024/0159582 A1
(43) Pub. Date: May 16, 2024

(54) OPTICAL TIME-OF-FLIGHT LEVEL SENSING FOR CAR WASH CHEMICALS

(71) Applicant: Sonny's HFI Holdings, LLC, Wilmington, DE (US)

(72) Inventors: Ken Martin, Little Canada, MN (US); Connor Findlay, Shakopee, MN (US); Jack Kuckhahn, Prior Lake, MN (US); Alison Kratzke, Stillwater, MN (US); Nate Schlueter, Bloomington, MN (US); Anna Tollefson, Prior Lake, MN (US); Matt Olsen, Bloomington, MN (US); Brandon Hoffman, Shakopee, MN (US); Ethan Kapler, Farmington, MN (US); Caleb Hatch, Prior Lake, MN (US); Jacob Boldenow, Woodbury, MN (US)

(21) Appl. No.: 18/388,392

(22) Filed: Nov. 9, 2023

Related U.S. Application Data
(60) Provisional application No. 63/424,240, filed on Nov. 10, 2022.
(60) Provisional application No. 63/500,418, filed on May 5, 2023.
(60) Provisional application No. 63/500,361, filed on May 5, 2023.

(51) Int. Cl. G01F 23/64

(52) U.S. Cl. CPC G01F 23/64

(57) ABSTRACT

An optical chemical level-sensing device includes an elongated tube for insertion into a top opening of a storage container, with a portion extending above the top of the storage container, which couples to a sealed control unit. A float device resides in the elongated tube in the storage container containing a liquid chemical solution, which includes a target surface configured to reflect optical signals. The sealed control unit includes an optical time-of-flight sensor and a lens that serves as a physical barrier between the liquid chemical solution and the optical time-of-flight sensor, while also allowing optical signals to pass through. The optical time-of-flight sensor emits optical signals through the lens toward the target surface of the float device and measures a return time of reflections of the optical signals off of the target surface to determine a level of the liquid chemical solution within the storage container.

### CROSS REFERENCE TO RELATED APPLICATIONS

This application claims priority to U.S. Provisional Patent Application No. 63/424,240, filed on Nov. 10, 2022 and entitled “Optical Time-of-Flight Level Sensing for Car Wash Chemicals”, U.S. Provisional Patent Application No. 63,500,418, filed on May 5, 2023 and entitled “Optical Time-of-Flight Level Sensing for Car Wash Chemicals”, and U.S. Provisional Patent Application No. 63/500,361, filed May 5, 2023 and entitled “Insert Assemblies for Fluid Distribution, Systems and Methods of Use”, each of which is herein incorporated by reference in the entirety and for all purposes.

### BACKGROUND

In automatic car washes, cars may advance through a carwash “tunnel” by a conveyor and various cleaning and related operations are performed at locations along the tunnel by equipment mounted to arches and other supports. A tunnel control activates the various pieces of washing equipment as the car is moved along the tunnel. A number of chemicals in water solutions may be applied during the washing process, such as presoaks, wheel cleaners, soaps, foaming detergents, waxes, drying agents, protectants, etc. The particular chemical solutions applied to a given car may vary based on wash packages optionally selected by a customer.

The various chemical solutions may be stored in containers, typically drums or tanks, and may be drawn out during a wash cycle, and mixed with water to provide a diluted chemical solution to be used for application to cars passing through the tunnel. In order to maintain continuous operation of the car wash, preventing any of the chemical solutions from being depleted is an important consideration. Conventional systems to monitor levels in the chemical solutions tend to lack necessary robustness for continuous, reliable operation.

### SUMMARY

An optical chemical level-sensing device, according to implementations, may include an elongated tube including a length greater than a height of a storage container configured to store a liquid chemical solution. During installation, the elongated tube may be configured to be inserted into a hole in a top of the storage container until a bottom end rests at or near a bottom portion of the storage container with a portion of the elongated tube extending above the top of the storage container. The bottom end of the elongated tube may be configured to allow liquid to flow into and out of the elongated tube while installed in the storage container such that a level of the liquid chemical solution within the elongated tube corresponds to a level of the liquid chemical solution in the storage container. A float device may be configured to be inserted into the elongated tube and to move vertically within the elongated tube in response to changes in the level of the liquid chemical solution. The float device may include a target surface facing toward the top of the storage container and vertically-positioned at a height within the elongated tube equal to or slightly above the level of the liquid chemical solution within the elongated tube, and the target surface may be configured to reflect optical signals. A sealed control unit may be configured to be positioned on a top end of the elongated tube, and may include an optical time-of-flight sensor and a lens. The lens may be configured to provide a physical barrier between the liquid chemical solution and the optical time-of-flight sensor, while also allowing the optical signals to pass through. The optical time-of-flight sensor may be configured to emit optical signals through the lens toward the target surface of the float device and to measure a return time of reflections of the optical signals off of the target surface to determine the level of the liquid chemical solution within the storage container.

In various implementations and alternatives, the target surface may include a shape defined by a top face of the float device. In some cases, the float device may include a body portion extending between the target surface and a base, and the base may have a star shape and the body portion has a smaller diameter than the target surface and the base. In additional or other cases, the float device may include an outer portion adjacent the target surface having external ribs configured to interleave with elongated grooves formed vertically in inner sidewalls of the elongated tube to control rotation of the float device as it moves within the elongated tube.

In various implementations and alternatives, the sealed control unit may include a processor configured to communicate with the optical time-of-flight sensor to receive time-of-flight data and to determine the level of the liquid chemical solution within the storage container based on the time-of-flight data. In some cases, the processor may be further configured to wirelessly communicate the level of the liquid chemical solution to an external computing device. In additional or other cases, the processor may be configured to adjust the determined level of the liquid chemical solution based on an orientation of the optical time-of-flight sensor relative to the surface of the liquid chemical solution in the storage container. In such cases, the sealed control unit may include a position sensor configured to detect the orientation of the optical time-of-flight sensor relative to the surface of the liquid chemical solution in the storage container.

In addition or alternatively, the optical time-of-flight sensor includes a light detection and ranging (LiDAR) sensor, and/or the float device may include a splined device with sidewalls including vertical ribs and grooves.

A chemical level sensing system, according to implementations, may include a processor, an optical time-of-flight sensor communicatively coupled to the processor, a control unit containing at least the sensor and a protective lens. The sensor may be arranged behind the lens such that the sensor is protected within an interior of the control unit. An elongated tube may be coupled to the control unit and configured to be inserted vertically through an opening in a storage container. A float device may be arranged in the elongated tube and configured to be movable. The sensor may be configured to transmit signals through the lens to sense a distance between the sensor and the float arranged in the elongated tube when the elongated tube is arranged in the storage container containing a liquid chemical solution. A bottom end of the elongated tube may be configured to allow liquid ingress and egress while installed in the storage container such that a level of the liquid chemical solution within the elongated tube corresponds to a level of the liquid chemical solution in the storage container. Based on a sensed distance between the sensor and the float, the processor may calculate a level of the liquid chemical solution present in the storage container.

In various implementations and alternatives, the processor may be configured to adjust the calculated level of the liquid chemical solution present in the storage container based on an orientation of the optical time-of-flight sensor relative to a surface of the liquid chemical solution within the storage container.

A solution delivery system, according to implementations, may include chemical level sensing and a dilution control system, and the dilution control system may integrate the processor of the chemical level sensing system into a single assembly.

A chemical level sensing system, according to implementations, may include a control unit containing a processor and an optical time-of-flight sensor communicatively coupled to the processor. The control unit may include a protective lens, and the sensor may be is arranged behind the lens such that the sensor is protected within an interior of the control unit. An elongated tube may be coupled to the control unit and configured to be inserted vertically through an opening in a storage container. A float may be arranged in the elongated tube and configured to be movable. The sensor may be configured to transmit signals through the lens to sense a distance between the sensor and the float arranged in the elongated tube when the elongated tube is arranged in the storage container containing a chemical solution undergoing egress therefrom such that a level of the liquid chemical solution within the elongated tube corresponds to a level of a liquid chemical solution in the storage container. Based on a sensed distance between the sensor and the float, the processor may be configured to calculate a level of a chemical present in the storage container during such egress.

In various implementations and alternatives, the processor or another processor of the chemical level sensing system may cause a rate of the egress of the liquid chemical solution to be adjusted based on a target level of chemical delivery. In addition or alternatively, an end cap may be installed at a lower end of the elongated tube, which end cap may be configured to block the float from leaving the tube while allowing the liquid chemical solution to enter and exit the tube. In addition or alternatively, the processor or another processor may be communicatively coupled to a metering device configured to adjust the rate of egress of the chemical, the metering device may include a chemical inlet of an eductor configured to receive the chemical and a motive fluid in a mixing chamber thereof, and a size of an orifice supplying the chemical to the chemical inlet may be adjusted to reach a target level of chemical delivery. In addition or alternatively, the processor or another processor may be communicatively coupled to a metering device configured as a positive displacement pump, the positive displacement pump may be configured to impinge on a chemical delivery tube of the metering device, and a rate of displacement of the chemical from the chemical delivery tube may be adjusted to reach the target level chemical delivery. In addition or alternatively, a solution delivery system may include the chemical level sensing system.

### BRIEF DESCRIPTION OF THE DRAWINGS

FIG. 1 is a system diagram of a level sensing system that includes multiple optical level-sensing devices, according to embodiments of the disclosure.

FIGS. 2A-2D depict various views of a level-sensing system including an optical level-sensing device, according to embodiments of the disclosure.

FIGS. 3A1, 3A2 and 3B depict various views of an optical level-sensing device, according to embodiments of the disclosure.

FIG. 4 is a side view of a float device, according to embodiments of the disclosure.

FIG. 5 is a side view of a second example of a float device, according to embodiments of the disclosure.

FIGS. 6A1, 6A2 and 6B depict various views of a control unit of an optical level-sensing device, according to embodiments of the disclosure.

FIG. 6C depicts a control unit of an optical level-sensing device, according to variants of the disclosure.

FIG. 7 depicts a cross-section of the elongated tube and a cross-section of the float device, in accordance with embodiments of the disclosure.

FIGS. 8A-8C depict various views of a level-sensing system including an in-tank portion of an optical level-sensing device, according to embodiments of the disclosure.

FIGS. 9A and 9B depict various views of an in-tank portion of an optical level-sensing device, according to embodiments of the disclosure.

FIGS. 10A and 10B depict various views of a level-sensing system including an optical level-sensing device with an in-tank portion and a control unit, according to embodiments of the disclosure.

FIG. 11A illustrates a dilution control system that may be integrated with the level sensing systems, according to embodiments of the present disclosure.

FIG. 11B illustrates a dilution control system that may be integrated with the level sensing systems, according to embodiments of the present disclosure.

### DETAILED DESCRIPTION

Vehicle wash components configured to control and monitor vehicle wash operations are provided, along with vehicle wash systems that include these vehicle wash components, as well as computer networks communicatively coupled thereto. The components described in the present disclosure are also applicable more generally in chemical distribution systems where distributed chemicals are contained in a vessel, which vessel requires periodic replacement or the viscous or liquid chemical requires replenishment to maintain the operation of chemical distribution system.

The term “vehicle wash location” encompasses a car wash and other related vehicle wash locations that are used by consumers and companies to clean motorized vehicles such as cars and trucks. The terms “vehicle wash” and “car wash” may be used interchangeably. Such locations may be more generally a chemical distribution location where the vessel(s) containing the viscous or liquid chemical and the chemical distribution system are located, and such locations may include but are not limited to industrial locations, restaurants, retail locations, or other locations where corrosive chemicals are stored and locally distributed, e.g., distributed for use and application at the location itself.

This disclosure describes an optical level-sensing device for measuring a level of a viscous or liquid chemical in a storage container using an optical time-of-flight sensor (e.g., a light detection and ranging (LiDAR) sensor) in conjunction with a target surface. The target surface may be a top surface of a float device that is configured to float in the viscous or liquid chemical such that the target surface of the float device is even with or above a top surface of the viscous or liquid chemical and is oriented substantially perpendicular to a direction of the optical signals transmitted from the optical time-of-flight sensor. The optical time-of-flight sensor may be configured to emit optical signals and to determine a time for those signals to be reflected back from the target surface of the float device. Such optical signals may be emitted through a protective lens. Based on the return time, the optical level-sensing device may calculate a current level of the viscous or liquid chemical within the storage container.

The float device may be retained in an elongated tube. The elongated tube may have a length that is greater than a height of the storage container. When installed, the elongated tube containing the float device may be inserted through a hole or opening (e.g., the opening having a slightly larger diameter than an outer diameter of the elongated tube), such as a grommet defined in a cap of the container, in the top of the storage container until a first end contacts the bottom of the storage container, with the second end and attached control unit located a short distance above a top end of the storage container. An attachment cap or clamp may be slid up and down the elongated tube, and when installed, may remain outside the storage container and may attach to a lip around the hole or opening in the top of the storage container to hold the elongated tube in place. In some examples, the elongated tube may be opaque to prevent the optical signals from escaping the elongated tube and/or to prevent stray reflections that may occur should the elongated tube be transparent. The elongated tube may be chemical-resistant. In some examples, the elongated tube may include a bottom end cap with side perforations/apertures/holes and/or notches cut out of a bottom surface to allow the viscous or liquid chemical to flow into or out of the elongated tube as the level in the storage container changes.

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

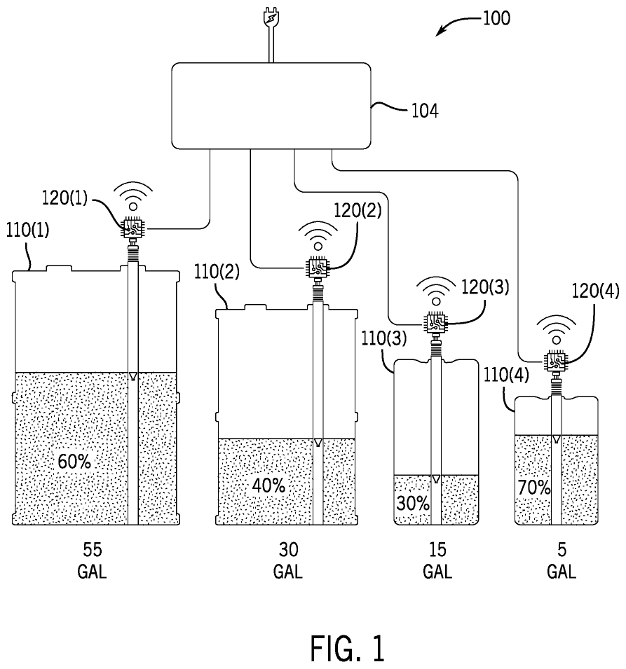

FIG. 1 is a system diagram of a level sensing system 100 that includes multiple optical level-sensing devices 120(1)-(4), according to embodiments of the disclosure. Each of the optical level-sensing devices 120(1)-(4) may be inserted into a respective storage container 110(1)-(4) to detect a level therein. A power box or supply 104 may provide power to the optical level-sensing devices 120(1)-(4) to power circuitry of the optical level-sensing devices 120(1)-(4). The power box or supply 104 may be configured as a breaker box, a power store such as a battery, or other source of power such as via an electrical connection.

Each of the optical level-sensing devices 120(1)-(4) may include an elongated tube, a control unit, and a float device. The float device may be retained in the elongated tube. The elongated tube may have a length that is greater than a height of the respective the respective storage container 110(1)-(4) in which it is installed. The elongated tube may be constructed from rigid material in order to provide structural support for the control unit. When installed, the elongated tube containing the float device may be received in or inserted through a hole or opening (e.g., the opening having a slightly larger diameter than an outer diameter of the elongated tube) in the top of the respective storage container 110(1)-(4) until a first (e.g., lower or bottom) end rests at or near a bottom portion of the storage container such as contacts the bottom of the respective storage container 110(1)-(4), with a second (e.g., upper or top) end and attached control unit located a short distance above a top of the respective storage container 110(1)-(4). An attachment cap or clamp may be slid up and down the elongated tube, and when installed, may remain outside the respective storage container 110(1)-(4) and may attach to a lip around the hole or opening defined in the top of the storage container to hold the elongated tube in place. In some examples, the elongated tube may be opaque to prevent the optical signals from escaping the elongated tube and/or to prevent stray reflections that may occur should the elongated tube be transparent. In some examples, the elongated tube may include a bottom end cap with side perforations/apertures/holes and/or notches cut out of a bottom surface to allow the viscous or liquid chemical to flow into or out of the elongated tube as the level in the respective storage container 110(1)-(4) changes.

The target surface formed on a top face of the float device may have a surface area that is based a cross-sectional surface area formed by interior or inside walls of the elongated tube. An outer-most diameter of the target surface of the float device may be slightly less than an inner diameter of the elongated tube such that the float device is free to move vertically within the elongated tube as the level of the viscous or liquid chemical changes, while also providing a large target surface for the optical time-of-flight sensor. In some examples, the target surface may consume the entire top face of the float device.

Along with an outermost diameter of the float device being only slightly smaller than the cross sectional diameter of the elongated tube, the float device may have a center of buoyancy and a center of gravity that maintains the target surface in an upward-facing direction. In some examples, the float device may include other features to hold the target surface substantially perpendicular to the direction of the optical signals transmitted from the optical time-of-flight sensor when the reservoir is titled at a slight angle. In some examples, the float device may have vertical splined sidewalls formed between symmetrical top and bottom surfaces. In another example, the float device may be a conical shape starting with a larger radius at the target surface to a smaller area next to a base. In this example float device, the base of the float device may have a sufficient size and mass to maintain the center of buoyancy to maintain the target surface in an upward-facing direction. In this example float device, the base may have a star-like shape, with an outer-most radius formed by the star being slightly smaller than the inside radius of the elongated tube. In some examples, the axial length of the float device is greater than a radius of the target surface.

The control unit of the optical level-sensing device (e.g., control unit) may have a sealed outer housing containing the optical time-of-flight sensor may be mounted on the second (e.g., upper or top) end of the elongated tube, with the elongated tube supporting the control unit. The control unit may include a physical barrier between the optical time-of-flight sensor and the opening at the end of the elongated tube to prevent the viscous or liquid chemical, including any vapors therefrom, from coming into contact with the optical time-of-flight sensor. The housing may be chemical- and water-resistant. In some examples, the physical barrier is a transparent material to allow the optical signals to pass through as they are transmitted from the optical time-of-flight sensor and reflected back from the target surface. In some examples, the physical barrier is a lens that is configured to focus the optical signals to a point on the optical time-of-flight sensor. Use of the optical time-of-flight sensor provides advantages over other types of sensors, such as ultrasonic sensors, at least because of this ability to completely enclose the optical time-of-flight sensor and other electronics via the physical barrier to mitigate corrosion and other wear or damage caused by direct contact with the viscous or liquid chemical.

In some examples, the control unit may include a microprocessor (e.g., microcontroller, processor, computing device, etc.) that is programmed to carry out various processing functions for the optical level-sensing device, including operation the optical time-of-flight sensor and other circuitry to perform the liquid level measuring analysis, detection of errors, operation of wireless transceivers (e.g., universal wireless hardware) to provide data and/or status information to an external system, operate an indicator (e.g., light indicator to provide notifications via various colors or flashing patterns, an audio device to provide aural notifications, etc.) to provide status or error indications. The wireless communication may be conducted from using Wi-Fi, BlueTooth®, or other wireless communication technologies. The communication of data with the external system may include, aside from a level indication and status/error messages, tank identification, date and time stamps, temperature information, etc. The data may be transmitted to a computing device via the Internet to allow offsite reference of the state of the optical level-sensing device and a measured level of the viscous or liquid chemical. The computing device may use the data to generate reports and analysis of the data, such as usage, costs, at regular intervals and generate alerts therefrom for leaks, low/high drum liquid levels, under/over usages of the anomalies in liquid level changes, and other conditions needing attention.

In some examples, the control unit may further include a motion or orientation sensing device to detect whether the level sensing device has moved and/or the orientation of the level sensing device. For example, the motion or orientation sensing device may detect when the level sensing device is moved as it is inserted into or removed from the storage container. This movement can be indicative of a process of changing the storage container or filling of the storage container. The motion or orientation sensing device may detect whether the level sensing device has been laid down mostly horizontally for an extended period of time. In some examples, this may be used to alert operators that the level sensing device is not properly installed. In some examples, the motion or orientation sensing device may provide an indication to the microprocessor of a vertical orientation of the level sensing device. The microprocessor may use the vertical orientation information to analyze a fluid level in the storage container. For example, if the motion or orientation sensing device indicates that the level sensing device is offset from a vertical position by a certain angle, the microprocessor may adjust a detected level of the storage container based on the certain angle to provide a more accurate detected fluid level. In some examples, the motion or orientation sensing device may also detect a rapid acceleration or movement of the level sensing device, which may cause the microprocessor to alert operators. The motion or orientation sensing device may be a multi-axis accelerometer, a gyro, or any combination thereof.

In some examples, the control unit may further include the indicator to provide notice of a status of the level sensor. For example, the indicator may include a light capable of emitting various colors and/or flash patterns to provide various status notifications, such as general fill levels of the storage container, an empty indication, detected faults or errors with the level sensor device (e.g., a disconnected level sensor, a defective level sensor, a sensor out of the drum, and a contaminated sensor or target surface, etc. The indicator may be a LED configured to illuminate in different colors based on a status of the level sensor, such as a first color (e.g., red) when the level sensor determines the storage container 210 is empty or at a low level, a second color (e.g., yellow) when the level sensor determines a different, less critical, level of the contents of the storage container 210, and a third color (e.g., green) when the level is high. In addition, the same or different colors may illuminate based other status determination by the sensor, such as the previously described faults or errors. In a particular example, the LED may illuminate in a flash pattern or a color that differs from colors assigned to the sensed levels to indicate such faults or errors. Further, each fault or error may be assigned its own color or flash pattern.

In some examples, the described optical level-sensing device may be used in automatic car wash systems to provide a way to monitor levels of car wash soaps and other chemicals used during a car wash process.

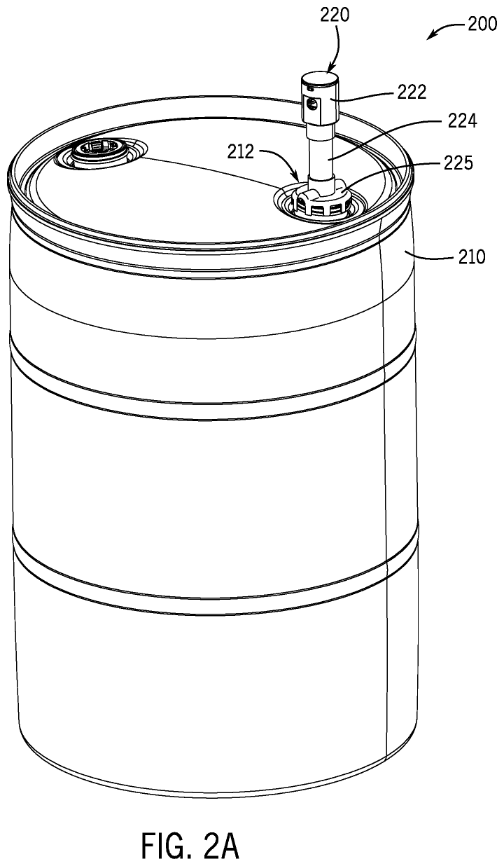

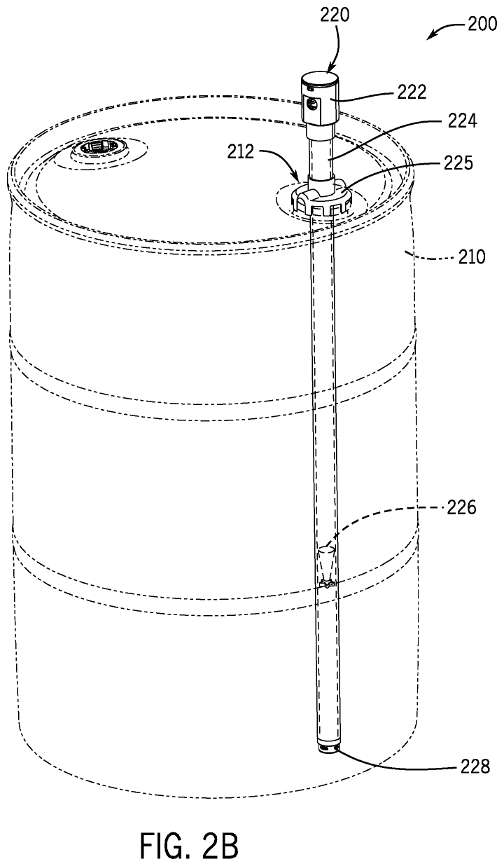

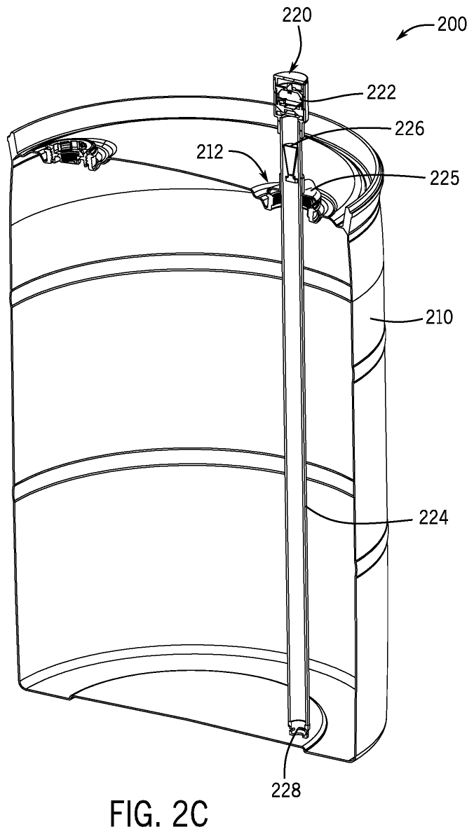

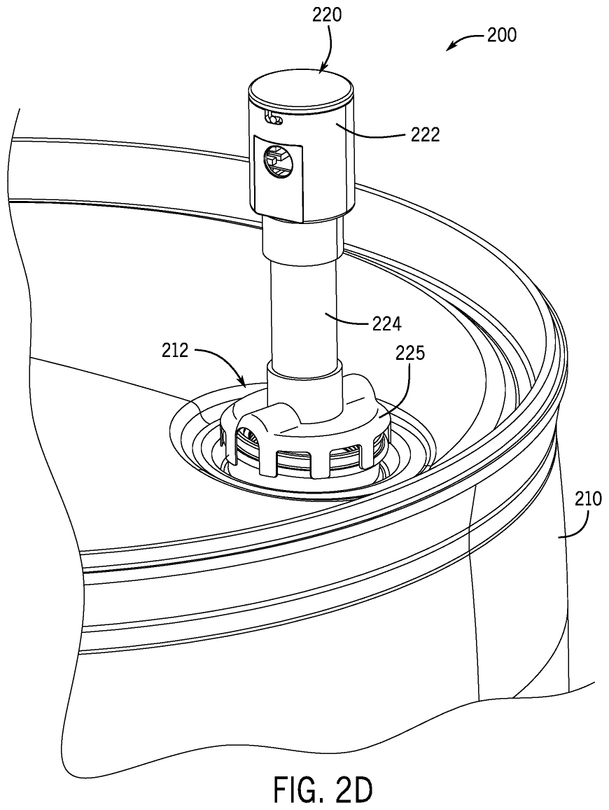

FIGS. 2A-2D depict various views of a level-sensing system 200 including an optical level-sensing device 220, according to embodiments of the disclosure. The optical level-sensing device 220 may be inserted into a storage container 210 to detect a level therein. The optical level sensing devices 120(1)-(4) of FIG. 1 may implement the optical level-sensing device 220 of FIGS. 2A-2D, in some examples.

The optical level-sensing device 220 may include an elongated tube 224, a control unit 222, and a float device 226. The float device 226 may be retained in the elongated tube 224. FIG. 2A illustrates an isometric view of the level-sensing system 200 installed in the storage container 210. FIG. 2B illustrates an isometric view of the level-sensing system 200 installed in the storage container 210 and a float device 226 shown in phantom lines. FIG. 2C illustrates a cross-section view of the level-sensing system 200 installed in the storage container 210. FIG. 2D illustrates an isometric view of a portion of the level-sensing system 200 installed at an exterior of the storage container 210. The elongated tube 224 may have a length that is greater than a height of the storage container 210 in which it is installed such that the elongated tube may extend above a covering or lid of the storage container 210. The elongated tube 224 may be constructed from rigid material in order to provide structural support for the control unit. When installed, the elongated tube 224 containing the float device 226 may be inserted through a hole or opening 212 (e.g., the opening 212 having a slightly larger diameter than an outer diameter of the elongated tube) defined in the top of the storage container 210 until a first (e.g., lower or bottom) end contacts the bottom of the storage container 210, with a second (e.g., upper or top) end and attached control unit located a short distance above a top of the storage container 210. The elongated tube may be configured to allow for liquid ingress and egress such that the liquid will flow into and out of the elongated tube while installed in the storage container such that a level of the liquid chemical solution within the elongated tube corresponds to a level of the liquid chemical solution in the storage container. An attachment cap or clamp 225 may be slid up and down the elongated tube 224, and when installed, may remain outside the storage container 210 and may attach to a lip around the hole or opening 212 in the top of the storage container to hold the elongated tube 224 in place. In some examples, the elongated tube 224 may be opaque to prevent the optical signals from escaping the elongated tube 224 and/or to prevent stray reflections that may occur should the elongated tube 224 be transparent. In some examples, the elongated tube 224 may include a bottom end cap 228 with side perforations/apertures/holes and/or notches cut out of a bottom surface to allow the viscous or liquid chemical to flow into or out of the elongated tube 224 as the level in the storage container 210 changes.

The float device 226 may be include a target surface facing toward a top of the storage container and vertically-positioned at a height within the elongated tube equal to or slightly above the level of the liquid chemical solution within the elongated tube. The target surface may be configured to reflect optical sensors. For instance, the target surface formed on a top face of the float device 226 may have a surface area that is based on a cross-sectional surface area formed by inside walls of the elongated tube 224. An outer-most diameter of the target surface of the float device 226 may be slightly less than an inner diameter of the elongated tube 224 such that the float device 226 is free to move vertically within the elongated tube 224 as the level of the viscous or liquid chemical changes, while also providing a large target surface for the optical time-of-flight sensor. In some examples, the target surface may consume the entire top face of the float device 226.

Along with an outermost diameter of the float device 226 being only slightly smaller than the cross sectional diameter of the elongated tube, the float device 226 may have a center of buoyancy and a center of gravity that maintains the target surface in an upward-facing direction. In some examples, the float device 226 may include other features to hold the target surface substantially perpendicular to the direction of the optical signals transmitted from the optical time-of-flight sensor when the storage container 210 is titled at a slight angle. In some examples, the float device 226 may have vertical splined sidewalls formed between symmetrical top and bottom surfaces. In another example, float device 226 may be a conical shape starting with a larger radius at the target surface to a smaller area next to a base. In this example float device 226, the base of the float device 226 may have a sufficient size and mass to maintain the center of buoyancy to maintain the target surface in an upward-facing direction. In this example float device 226, the base may have a star-like shape, with an outer-most radius formed by the star being slightly smaller than the inside radius of the elongated tube 224. In some examples, the axial length of the float device 226 is greater than a radius of the target surface. In some examples, the float device may be constructed of a durable, chemically resistant polymer such as high density polyethylene (HDPE), polyether ether ketone (PEEK) and variations and combinations thereof.

An outer housing around the control unit 222 may form a sealed enclosure containing the optical time-of-flight sensor, and may be mounted on the second or top end of the elongated tube 224, with the elongated tube 224 supporting the control unit 222. The control unit 222 may include a physical barrier between the optical time-of-flight sensor and the opening at the end of the elongated tube 224 to prevent the viscous or liquid chemical, including any vapors therefrom, from coming into contact with the optical time-of-flight sensor. In some examples, the physical barrier is a transparent material to allow the optical signals to pass through as they are transmitted from the optical time-of-flight sensor and reflected back from the target surface. In some examples, the physical barrier is a lens that is configured to focus the optical signals to a point on the optical time-of-flight sensor. Use of the optical time-of-flight sensor provides advantages over other types of sensors, such as ultrasonic sensors, at least because of this ability to completely enclose the optical time-of-flight sensor and other electronics via the physical barrier to mitigate corrosion and other wear or damage caused by direct contact with the viscous or liquid chemical.

In some examples, the control unit 222 may include a microprocessor (e.g., microcontroller, processor, computing device, etc.) that is programmed to carry out various processing functions for the optical level-sensing device, including operation the optical time-of-flight sensor and other circuitry to perform the liquid level measuring analysis, detection of errors, operation of wireless transceivers to provide data and/or status information to an external system, operate an indicator (e.g., light indicator to provide notifications via various colors or flashing patterns, an audio device to provide aural notifications, etc.) to provide status or error indications. The wireless communication may be conducted from using Wi-Fi, BlueTooth®, or other wireless communication technologies. The communication of data with the external system may include, aside from a level indication and status/error messages, tank identification, date and time stamps, temperature information, etc. The data may be transmitted to a computing device via the Internet to allow offsite reference of the state of the optical level-sensing device and a measured level of the viscous or liquid chemical. The computing device may use the data to generate reports and analysis of the data, such as usage, costs, at regular intervals and generate alerts therefrom for leaks, low/high drum liquid levels, under/over usages of the anomalies in liquid level changes, and other conditions needing attention.

In some examples, the control unit 222 may further include a motion or orientation sensing device to detect whether the level sensing device has moved and/or the orientation of the level sensing device. For example, the motion or orientation sensing device may detect when the level sensing device is moved as it is inserted into or removed from the storage container. This movement can be indicative of a process of changing the storage container or filling of the storage container. The motion or orientation sensing device may detect whether the level sensing device has been laid down mostly horizontally for an extended period of time. In some examples, this may be used to alert operators that the level sensing device is not properly installed. In some examples, the motion or orientation sensing device may provide an indication to the microprocessor of a vertical orientation of the level sensing device. The microprocessor may use the vertical orientation information to analyze a fluid level in the storage container. For example, if the motion or orientation sensing device indicates that the level sensing device is offset from a vertical position by a certain angle, the microprocessor may adjust a detected level of the storage container based on the certain angle to provide a more accurate detected fluid level. In some examples, the motion or orientation sensing device may also detect a rapid acceleration or movement of the level sensing device, which may cause the microprocessor to alert operators. The motion or orientation sensing device may be a multi-axis accelerometer, a gyro, or any combination thereof.

In some examples, the control unit 222 may further include the indicator to provide notice of a status of the level sensor. For example, the indicator may include a light capable of emitting various colors and/or flash patterns to provide various status notifications, such as general fill levels of the storage container, an empty indication, detected faults or errors with the level sensor device (e.g., a disconnected level sensor, a defective level sensor, a sensor out of the drum, and a contaminated sensor or target surface, etc.

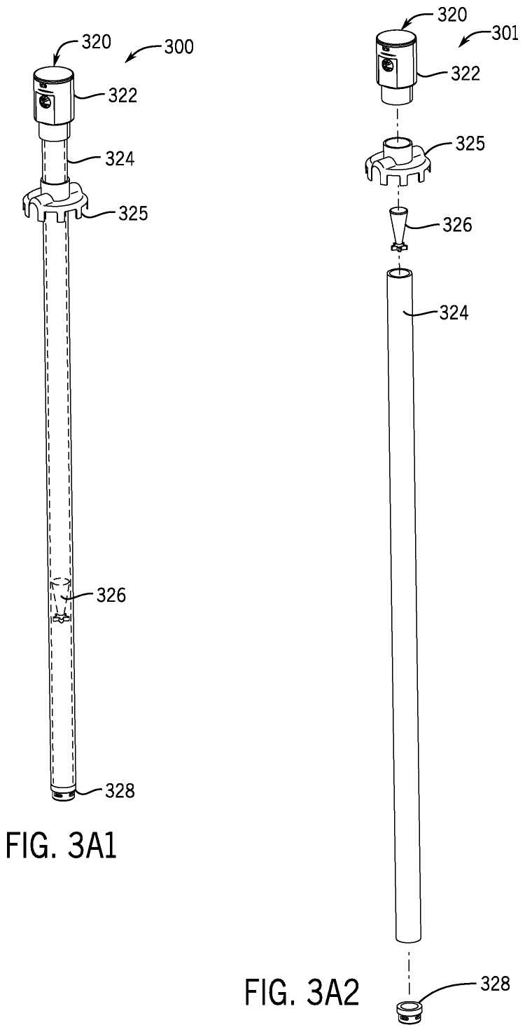

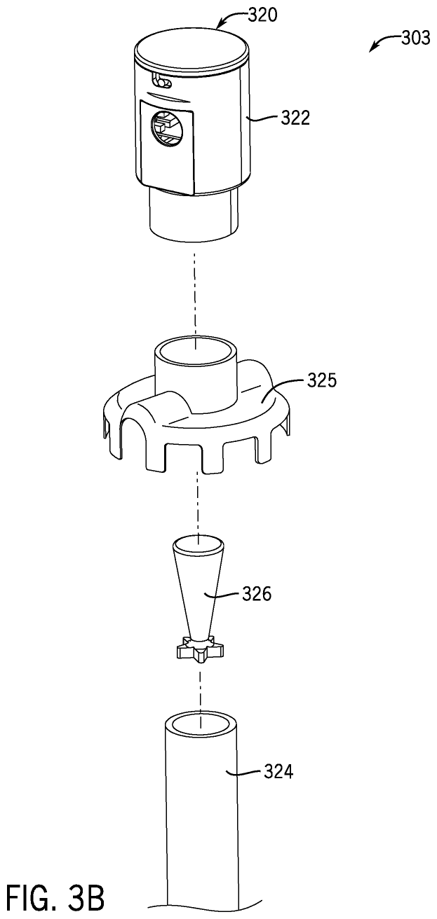

FIGS. 3A1, 3A2 and 3B depict various views of an optical level-sensing device 220, according to embodiments of the disclosure. The optical level sensing devices 120(1)-(4) of FIG. 1 and/or the optical level-sensing device 220 of FIGS. 2A-2D may implement the optical level-sensing device 320 of FIGS. 3A1, 3A2 and 3B, in some examples. View 300 of FIG. 3A1 is an assembled view of the optical level-sensing device 320, view 301 of FIG. 3A2 is an exploded view of the optical level-sensing device 320, and view 303 of FIG. 3B is an exploded view of an upper portion of the optical level-sensing device 320.

The optical level-sensing device 320 may include an elongated tube 324, a control unit 322, and a float device 326. The float device 326 may be retained in the elongated tube 324. The elongated tube 324 may have a length that is greater than a height of a storage container in which it is to be installed. The elongated tube 324 may be constructed from rigid material in order to provide structural support for the control unit. An attachment cap or clamp 325 may be slide up and down the elongated tube 324, and when installed, may remain outside the storage container and may attach to a lip around the hole or opening in the top of the storage container to hold the elongated tube 324 in place. In some examples, the elongated tube 324 may be opaque to prevent the optical signals from escaping the elongated tube 324 and/or to prevent stray reflections that may occur should the elongated tube 324 be transparent. In some examples, the elongated tube 324 may include a bottom end cap 328 with side perforations/apertures/holes and/or notches cut out of a bottom surface to allow the viscous or liquid chemical to flow into or out of the elongated tube 324 as the level in the storage container 210 changes.

The target surface formed on a top face of the float device 326 may have a surface area that is based a cross-sectional surface area formed by inside walls of the elongated tube 324. An outer-most diameter of the target surface of the float device 326 may be slightly less than an inner diameter of the elongated tube 324 such that the float device 326 is free to move vertically within the elongated tube 324 as the level of the viscous or liquid chemical changes, while also providing a large target surface for the optical time-of-flight sensor. In some examples, the target surface may consume the entire top face of the float device 326.

Along with an outermost diameter of the float device 326 being only slightly smaller than the cross sectional diameter of the elongated tube, the float device 326 may have a center of buoyancy and a center of gravity that maintains the target surface in an upward-facing direction. In some examples, the float device 326 may include other features to hold the target surface substantially perpendicular to the direction of the optical signals transmitted from the optical time-of-flight sensor when titled at a slight angle. In some examples, the float device 326 may have vertical splined sidewalls formed between symmetrical top and bottom surfaces. In another example, float device 326 may be a conical shape starting with a larger radius at the target surface to a smaller area next to a base. In this example float device 326, the base of the float device 326 may have a sufficient size and mass to maintain the center of buoyancy to maintain the target surface in an upward-facing direction. In this example float device 326, the base may have a star-like shape, with an outer-most radius formed by the star being slightly smaller than the inside radius of the elongated tube 324. In some examples, the axial length of the float device 326 is greater than a radius of the target surface.

An outer housing around the control unit 322 may form a sealed enclosure containing the optical time-of-flight sensor, and may be mounted on the second end of the elongated tube 324, with the elongated tube 324 supporting the control unit 322. The control unit 322 may include a physical barrier between the optical time-of-flight sensor and the opening at the end of the elongated tube 324 to prevent the viscous or liquid chemical, including any vapors therefrom, from coming into contact with the optical time-of-flight sensor. In some examples, the physical barrier is a transparent material to allow the optical signals to pass through as they are transmitted from the optical time-of-flight sensor and reflected back from the target surface. In some examples, the physical barrier is a lens that is configured to focus the optical signals to a point on the optical time-of-flight sensor. Use of the optical time-of-flight sensor provides advantages over other types of sensors, such as ultrasonic sensors, at least because of this ability to completely enclose the optical time-of-flight sensor and other electronics via the physical barrier to mitigate corrosion and other wear or damage caused by direct contact with the viscous or liquid chemical.

In some examples, the control unit 322 may include a microprocessor (e.g., microcontroller, processor, computing device, etc.) that is programmed to carry out various processing functions for the optical level-sensing device, including operation the optical time-of-flight sensor and other circuitry to perform the liquid level measuring analysis, detection of errors, operation of wireless transceivers to provide data and/or status information to an external system, operate an indicator (e.g., light indicator to provide notifications via various colors or flashing patterns, an audio device to provide aural notifications, etc.) to provide status or error indications. The wireless communication may be conducted from using Wi-Fi, BlueTooth®, or other wireless communication technologies. The communication of data with the external system may include, aside from a level indication and status/error messages, tank identification, date and time stamps, temperature information, etc. The data may be transmitted to a computing device via the Internet to allow offsite reference of the state of the optical level-sensing device and a measured level of the viscous or liquid chemical. The computing device may use the data to generate reports and analysis of the data, such as usage, costs, at regular intervals and generate alerts therefrom for leaks, low/high drum liquid levels, under/over usages of the anomalies in liquid level changes, and other conditions needing attention.

In some examples, the control unit 322 may further include a motion or orientation sensing device to detect whether the level sensing device has moved and/or the orientation of the level sensing device. For example, the motion or orientation sensing device may detect when the level sensing device is moved as it is inserted into or removed from the storage container. This movement can be indicative of a process of changing the storage container or filling of the storage container. The motion or orientation sensing device may detect whether the level sensing device has been laid down mostly horizontally for an extended period of time. In some examples, this may be used to alert operators that the level sensing device is not properly installed. In some examples, the motion or orientation sensing device may provide an indication to the microprocessor of a vertical orientation of the level sensing device. The microprocessor may use the vertical orientation information to analyze a fluid level in the storage container. For example, if the motion or orientation sensing device indicates that the level sensing device is offset from a vertical position by a certain angle, the microprocessor may adjust a detected level of the storage container based on the certain angle to provide a more accurate detected fluid level. In some examples, the motion or orientation sensing device may also detect a rapid acceleration or movement of the level sensing device, which may cause the microprocessor to alert operators. The motion or orientation sensing device may be a multi-axis accelerometer, a gyro, or any combination thereof.

In some examples, the control unit 322 may further include the indicator to provide notice of a status of the level sensor. For example, the indicator may include a light capable of emitting various colors and/or flash patterns to provide various status notifications, such as general fill levels of the storage container, an empty indication, detected faults or errors with the level sensor device (e.g., a disconnected level sensor, a defective level sensor, a sensor out of the drum, and a contaminated sensor or target surface, etc.

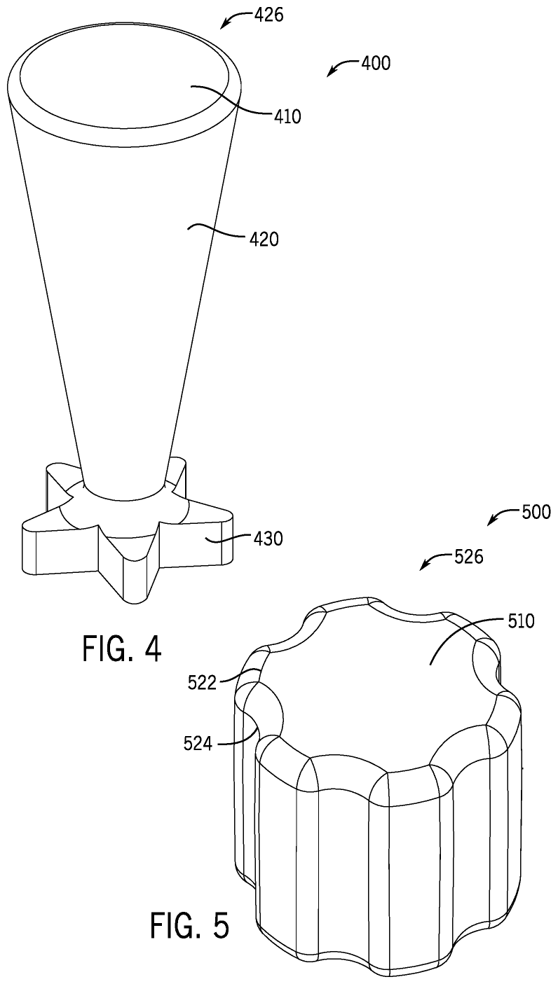

FIG. 4 is a side view 400 of a first example of a float device 426, according to embodiments of the disclosure. The optical level sensing devices 120(1)-(4) of FIG. 1, the float device 226 of FIGS. 2A-2D, and/or the float device 326 of FIGS. 3A1, 3A2 and 3B may implement the float device 426, in some examples. The float device 426 may include a target surface 410, a body 420, and a base 430.

The body 420 formed on a top face of the float device 426 may have a surface area that is based a surface area of the top surface of the viscous or liquid chemical formed by inside walls of the elongated tube in which it is to be installed. An outer-most diameter of the target surface 410 of the float device 426 may be slightly less than an inner diameter of the elongated tube such that the float device 426 is free to move vertically within the elongated tube as the level of the viscous or liquid chemical changes, while also providing a large target surface for the optical time-of-flight sensor. In some examples, the target surface 410 may consume the entire top face of the float device 426. In other examples, the float device 426 may include a bevel between the target surface 410 and the body 420.

The float device 426 may have a center of buoyancy and a center of gravity that maintains the target surface 410 in an upward-facing direction. In some examples, the float device 426 may include other features to hold the target surface substantially perpendicular to the direction of the optical signals transmitted from the optical time-of-flight sensor when titled at a slight angle. For example, the body 420 of the float device 426 may be a conical shape starting with a larger radius at the target surface 410 to a smaller area next to the base 430. The base 430 of the float device 426 may have a sufficient size and mass to maintain the center of buoyancy to maintain the target surface 410 in an upward-facing direction. In some examples, the base 430 may have a star-like shape, with an outer-most radius formed by the star being slightly smaller than the radius of the target surface 410. In some examples, the axial length of the float device 426 is greater than a radius of the target surface 410.

FIG. 5 is a side view 500 of a second example of a float device 526, according to embodiments of the disclosure. The optical level sensing devices 120(1)-(4) of FIG. 1, the float device 226 of FIGS. 2A-2D, and/or the float device 326 of FIGS. 3A1, 3A2 and 3B may implement the float device 526, in some examples. The float device 526 may include a target surface 510 with splined design with sidewalls having alternating splines or ribs 522 and grooves 524.

The target surface 510 of the float device 526 may have a surface area that is based a surface area of the inside cross section of an elongated tube in which it is to be installed. An outer-most diameter of the float device 526 (e.g., formed by the splines 522) may be slightly less than an inner diameter of the elongated tube such that the float device 526 is free to move vertically within the elongated tube as the level of the viscous or liquid chemical changes, while also providing a large target surface for the optical time-of-flight sensor. The splined design may improve fluid movement of the float device 526 within the elongated tube by reducing surface area along the sides potentially in contact with sidewalls of the elongated tube (e.g., as compared with a purely cylindrical design). In examples, the float device 526 may include a bevel or rounded edge between the target surface 510 and the ribs 522 and grooves 524.

Along with an outermost the diameter of the float device 526 being only slightly smaller than the inside diameter of the elongated tube, the float device 526 may have a center of buoyancy and a center of gravity that maintains the target surface 510 in an upward-facing direction.

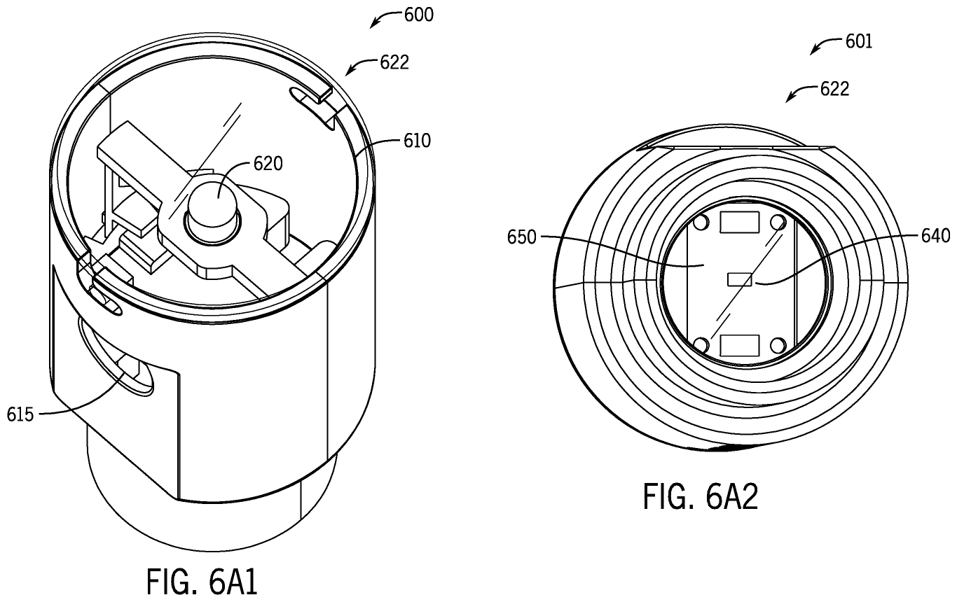

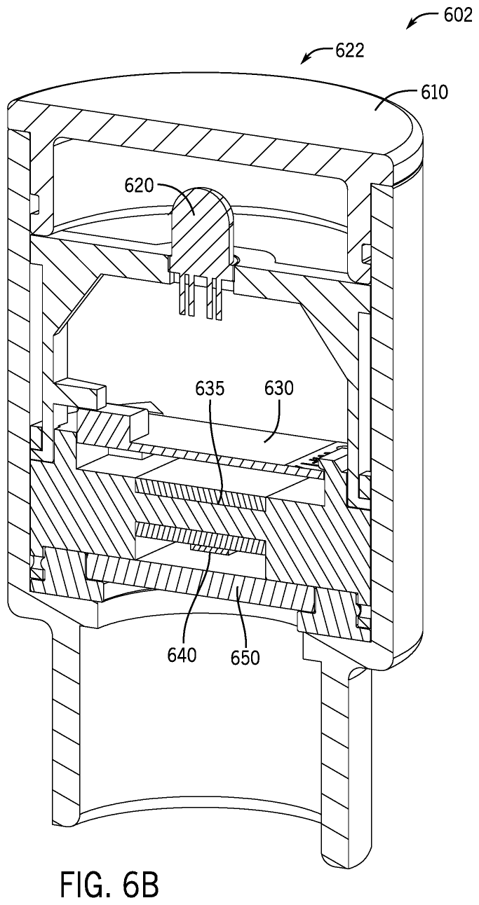

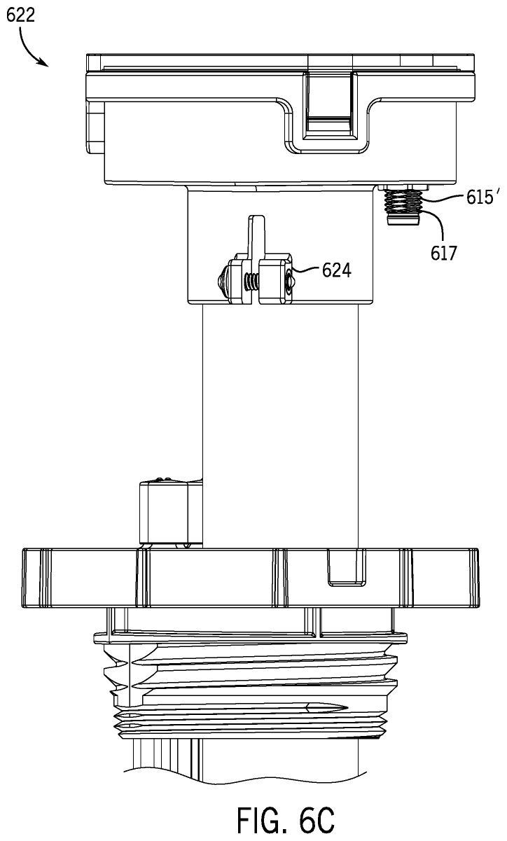

FIGS. 6A1, 6A2 and 6B depict various views of a control unit 622 of an optical level-sensing device, according to embodiments of the disclosure. The optical level sensing devices 120(1)-(4) of FIG. 1, the control unit 222 of FIGS. 2A-2D, and/or the control unit 322 of FIGS. 3A1, 3A2 and 3B may implement the control unit 622, in some examples. View 600 is an isometric top view of the control unit 622, view 601 is an isometric bottom view of the control unit 622, and view 602 is a cross-sectional view of the control unit 622.

The control unit 622 may include a top lens 610, a power port 615 to receive external power, an indicator 620, a microprocessor 630, a motion or orientation sensing device 635, an optical time-of-flight sensor 640, and a physical barrier 650. An outer housing of the control unit 622 may form a sealed enclosure containing the optical time-of-flight sensor 640. The power port 615 may be configured to receive external low voltage power to power the control unit 622. The control unit 622 may include a physical barrier 650 between the optical time-of-flight sensor 640 and a bottom opening to prevent the viscous or liquid chemical, including any vapors therefrom, from coming into contact with the optical time-of-flight sensor 640. In some examples, the physical barrier 650 is a transparent material to allow the optical signals to pass through as they are transmitted from the optical time-of-flight sensor 640 and reflected back from the target surface of the float device. In some examples, the physical barrier 650 is a lens that is configured to focus the optical signals to a point on the optical time-of-flight sensor 640. Use of the optical time-of-flight sensor 640 provides advantages over other types of sensors, such as ultrasonic sensors, at least because of this ability to completely enclose the optical time-of-flight sensor 640 and other electronics via the physical barrier 650 to mitigate corrosion and other wear or damage caused by direct contact with the viscous or liquid chemical.

In some examples, the microprocessor 630 (e.g., microcontroller, processor, computing device, etc.) may be programmed to carry out various processing functions for an optical level-sensing device, including operation the optical time-of-flight sensor 640 and other circuitry to perform the liquid level measuring analysis, detection of errors, operation of wireless transceivers to provide data and/or status information to an external system, operate the indicator 620 (e.g., cause the light indicator to provide notifications via emission of various colors or flashing patterns) to provide status or error indications. The wireless communication may be conducted from using Wi-Fi, BlueTooth®, or other wireless communication technologies. The communication of data with the external system may include, aside from a level indication and status/error messages, tank identification, date and time stamps, temperature information, etc. The data may be transmitted to a computing device via the Internet to allow offsite reference of the state of the optical level-sensing device and a measured level of the viscous or liquid chemical. The computing device may use the data to generate reports and analysis of the data, such as usage, costs, at regular intervals and generate alerts therefrom for leaks, low/high drum liquid levels, under/over usages of the anomalies in liquid level changes, and other conditions needing attention.

In some examples, the motion or orientation sensing device 635 may detect whether the level sensing device has moved and/or the orientation of the level sensing device has changed. For example, the motion or orientation sensing device 635 may detect when the level sensing device is moved as it is inserted into or removed from the storage container. This movement can be indicative of a process of changing the storage container or filling of the storage container. The motion or orientation sensing device 635 may detect whether the level sensing device has been laid down mostly horizontally for an extended period of time. In some examples, this may be used to alert operators that the level sensing device is not properly installed. In some examples, the motion or orientation sensing device 635 may provide an indication to the microprocessor of a vertical orientation of the level sensing device. The microprocessor may use the vertical orientation information to analyze a fluid level in the storage container. For example, if the motion or orientation sensing device 635 indicates that the level sensing device is offset from a vertical position by a certain angle, the microprocessor may adjust a detected level of the storage container based on the certain angle to provide a more accurate detected fluid level. In some examples, the motion or orientation sensing device 635 may also detect a rapid acceleration or movement of the level sensing device, which may cause the microprocessor to alert operators. In some examples, the motion or orientation sensing device 635 may be configured to accept physical interaction as human-machine interface (HMI). This may enable HMI functionality to exist while allowing the control unit 622 to be completely sealed and protected. For instance, a user may touch, tap or otherwise provide haptic input to the control unit 622, which may be sensed by the motion or orientation sensing device 635 and the microprocessor may determine the user is signaling that the storage container has been refilled or replaced. The motion or orientation sensing device 635 may be a multi-axis accelerometer, a gyro, or any combination thereof.

In some examples, the indicator 620 may be visible through the top lens 610 and may provide notice of a status of the level sensor. The indicator 620 may include a light capable of emitting various colors and/or flash patterns to provide various status notifications, such as general fill levels of the storage container, an empty indication, detected faults or errors with the level sensor device (e.g., a disconnected level sensor, a defective level sensor, a sensor out of the drum, and a contaminated sensor or target surface, etc.

FIG. 6C depicts the control unit 622 of an optical level-sensing device, according to variants of the disclosure. The components of the control unit 622 of FIG. 6C are substantially similar to those described in connection with FIGS. 6A1, 6A2 and 6B and are not repeated in the interest of brevity. FIG. 6C illustrates the housing of the control unit 622 with a power port 615′ configured with a threaded connector 617 extending from a lower portion of the housing of the control unit 622. Although the power port 615′ is illustrated with a threaded connector 617, the connector may include any engagement mechanism for coupling with a power source such as quick connections including compression or twist style engagement mechanisms, z-thread or quarter turn engagement mechanisms, snap detent mechanisms, clamp assemblies, and the like. The outer housing of the control unit 622 may be coupled to the elongated tube by a coupling device 624, for instance configured as a releasable clamp or a cam lock, e.g., clamping handle coupled to a split ring or clamp for establishing a pinch, compression, and/or friction lock.

The internal cross section of the elongated tube described with reference to FIGS. 1, 2A-2D, 3A1, 3A2 and 3B herein may take various shapes without departing from the scope of the disclosure. In some examples, the elongated tube may have an internal cross-section adapted to receive the float device (e.g., the float device 226 of FIGS. 2A-2D, the float device 326 of FIGS. 3A1, 3A2 and 3B, the float device 426 of FIG. 4, and/or the float device 526 of FIG. 5), where the float device may take one of various configurations and thus one of various external cross-sections. For instance, the elongated tube may have a circular internal cross-section, while the float device may have any one of a circular, oval, square, triangular, multi-point or faceted (e.g. 5-, 6-, 7-, or 8-point star or facet (e.g., scallop or square-shape protrusion)) external cross-section. In some examples, the elongated tube may have an internal cross-section complementary to the external cross-section of float device. For example, the elongated tube and float device may each have the same of any of the aforementioned cross-sections. In such implementations, the float device may be guided by the corresponding internal cross-section of the elongated tube as the level of the fluid in the storage container changes, and for instance the float device may be prevented from rotating or tilting, or may be prevented from rotating or tilting by more than a pre-defined angle, due to the complementary cross-sections.

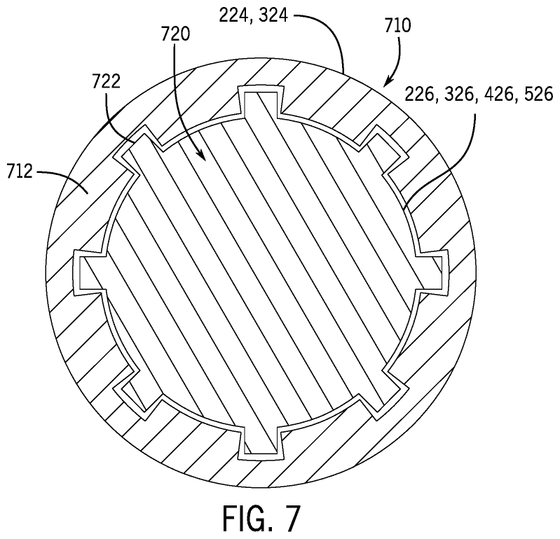

The complementary shape of the cross-sections may be the result of one or more structural features extending along all or a portion of the length of the elongated tube. For instance as shown in FIG. 7, the cross-section 710 of the elongated tube, e.g., elongated tube 224, 324 may contain elongated grooves 712 along an internal sidewall thereof, while the cross-section 720 of the float device, e.g., float device 226, 326, 426, 526, may include external ribs 722 configured to be received by the longitudinally extending grooves 712. The grooves 712 and ribs 722 may have any shape and for instance may have a V-shape, square, square with rounded edges, and so on. To further this example, one or more secondary structural feature may be incorporated into the elongated tube that causes the float device to rotate about a central axis of the float device or that causes the float device change position such as tilt. Such secondary structural features may be arranged at predetermined points along the longitudinal length of the elongated tube. For instance, where the elongated tube includes one or more longitudinally extending internal grooves 712, the secondary feature may be the one or groove extending circumferentially by about 10 to 90 degrees to form a thread-like portion that causes the ribs 722 of the float device to rotate by a corresponding amount as the float device travels along the elongated tube. In another example, some of the longitudinally extending internal grooves 712 may widen while opposing grooves 712 may taper to cause the float device to be urged towards the tapering grooves (e.g., to translate) within the elongated tube by a predetermine amount upon reaching the secondary feature. The system may be pre-programmed to detect a change in position of the float device as a result of movement along the secondary structural feature(s). For instance, where the float device may rotate by 10 to 90 degrees as the float device translates down the elongated tube upon reaching a thread-like secondary structural feature, this may result in the system determining or confirming that a remaining level of fluid in the container is at a pre-defined amount, such as 10-50 percent.

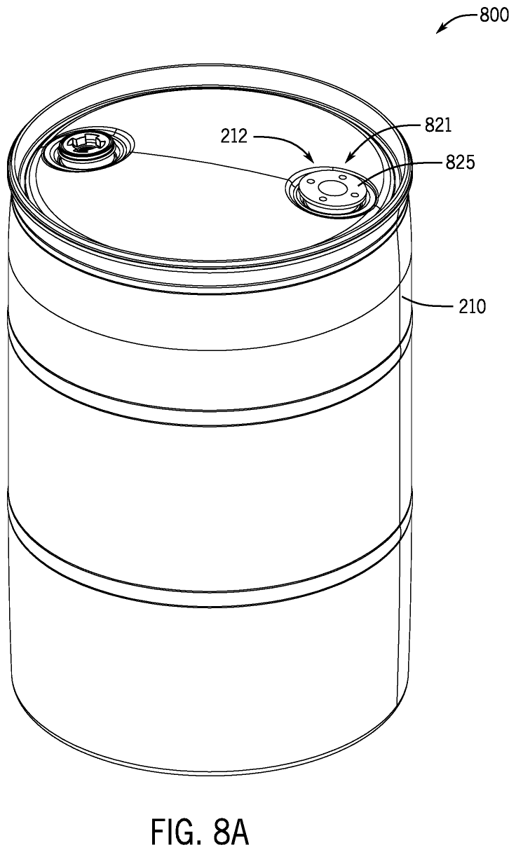

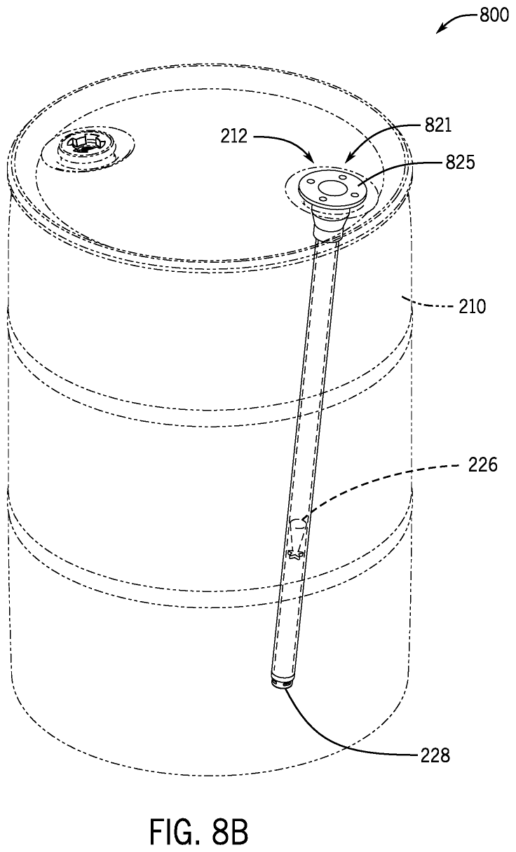

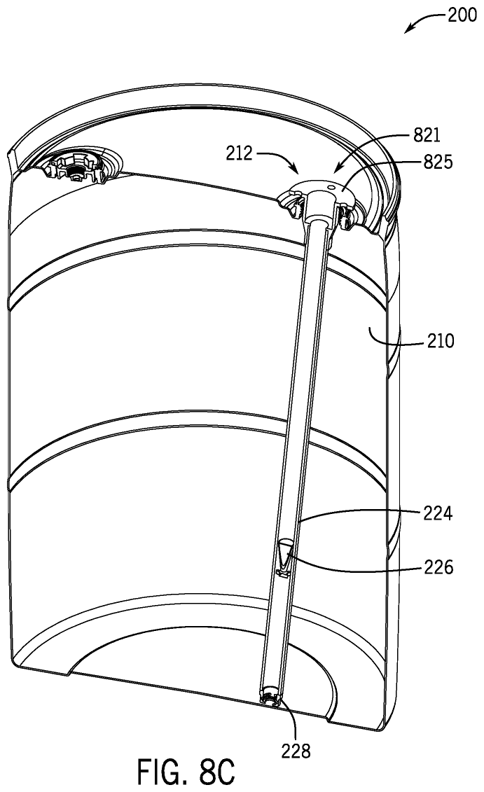

FIGS. 8A-8C depict various views of a level-sensing system 800 including an in-tank portion 821 of an optical level-sensing device, according to embodiments of the disclosure. FIG. 8A depicts an isometric view of the in-tank portion 821 of an optical level-sensing device installed in the storage container 210. FIG. 8B illustrates an isometric view of the in-tank portion 821 of an optical level-sensing device with the storage container 210 and the float device 226 shown in phantom lines. FIG. 8C illustrates a cross-section view of the in-tank portion 821 of an optical level-sensing device installed in the storage container 210. Accordingly, the in-tank portion 821 of an optical level-sensing device may be inserted into the storage container 210 to detect a level therein. The optical level sensing devices 120(1)-(4) of FIG. 1 may implement the in-tank portion 821 of the optical level-sensing device of FIGS. 8A-8C, in some examples. The level-sensing system 800 may include elements that have been previously described with respect to the level-sensing system 200 of FIGS. 2A-2D. Those elements have been identified in FIGS. 8A-8C using the same reference numbers used in FIGS. 2A-2D and operation of the common elements is as previously described. Consequently, a detailed description of the operation of these particular elements will not be repeated in the interest of brevity.

In the embodiment depicted in FIGS. 8A-8C, in-tank portion 821 of the optical level-sensing device may be part of the storage container 210 such that the storage container 210 is pre-installed with the in-tank portion 821 of the optical level-sensing device, as compared with the optical level-sensing device 200 of FIGS. 2A-2D, which is entirely installed on site. The in-tank portion 821 of the optical level-sensing device includes a flange 825 that interfaces with the top of the storage container 210 to plug the opening 212. The in-tank portion 821 of the optical level-sensing device may include a plug to prevent fluid from escaping out the top of the elongated tube 224 during shipment. When the storage container 210 arrives with the in-tank portion 821 of the optical level-sensing device, the plug may be removed, and a control unit (e.g., a control unit 222 of FIGS. 2A-2D, the control unit 322 of FIGS. 3A1, 3A2, and 3B, the control unit 622 of FIGS. 6A1, 6A2 and 6B, or combinations thereof) may be installed. The level sensing system 800 with the in-tank portion 821 of the optical level-sensing device may reduce or mitigate spillage by eliminating removing of the elongated tube from the storage container 210 for installation into a different storage container when the original storage container 210 is being replaced. The in-tank portion 821 of the optical level-sensing device also prevents cross-contamination of fluids that can be caused by moving the elongated tube between storage containers.

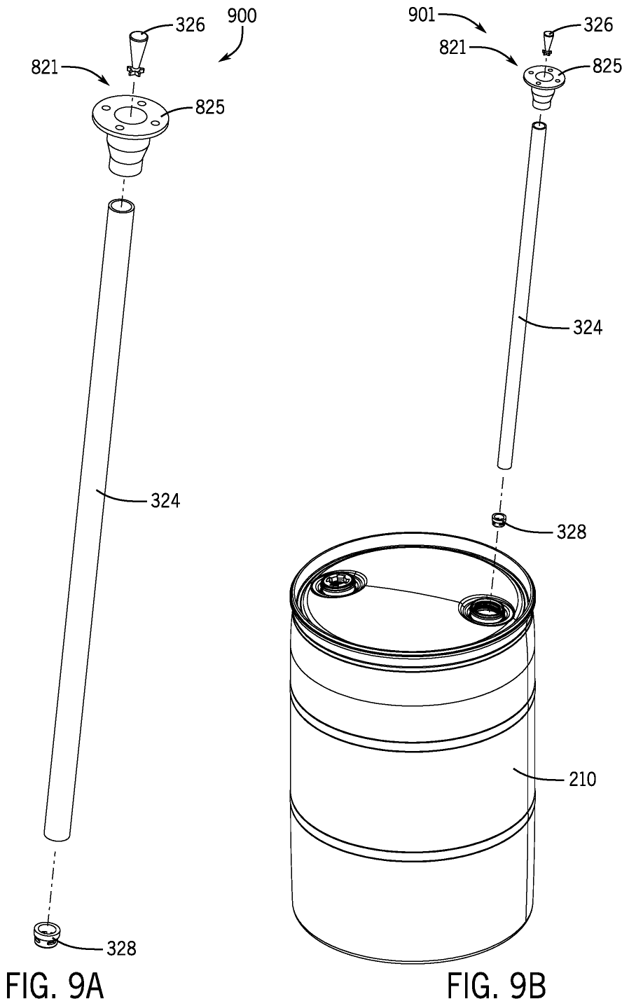

FIGS. 9A and 9B depict various exploded isometric views of an in-tank portion 821 of an optical level-sensing device, according to embodiments of the disclosure. The optical level sensing devices 120(1)-(4) of FIG. 1 and/or the in-tank portion 821 of the optical level-sensing device of FIGS. 8A-8C may implement the in-tank portion 821 of an optical level-sensing device, in some examples. View 900 is an exploded view of the optical level-sensing device 320, view 301 is an exploded view of the in-tank portion 821 of the optical level-sensing device, and view 901 is an exploded view of the in-tank portion 821 of the optical level-sensing device including the storage tank 210. The in-tank portion 821 of the optical level-sensing device may include elements that have been previously described with respect to the level-sensing system 200 of FIGS. 2A-2D, the level sensing device 320 of FIGS. 3A1, 3A2 and 3B, and/or the in-tank portion 821 of the optical level-sensing device of FIGS. 8A-8C. Those elements have been identified in FIGS. 9A and 9B using the same reference numbers used in FIGS. 2A-2D, 3A1, 3A2, 3B, and 8A-8C, and operation of the common elements is as previously described. Consequently, a detailed description of the operation of these particular elements will not be repeated in the interest of brevity.

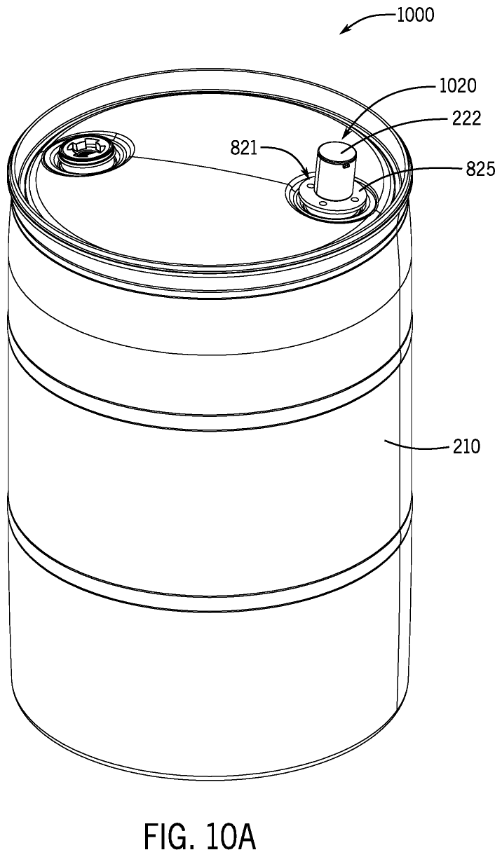

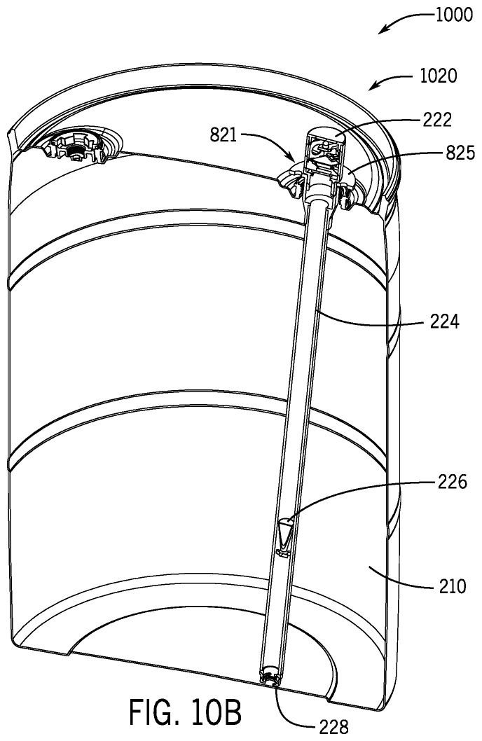

FIGS. 10A and 10B depict various views of a level-sensing system 1000 including an optical level-sensing device 1020 with an in-tank portion 821 and a control unit 222, according to embodiments of the disclosure. The in-tank portion 821 of the optical level-sensing device may be pre-installed into the storage container 210, and the control unit 222 may be installed into an opening of the flange 825 to detect a level therein. The control unit 222 unit may implement any of (e.g., a control unit 222 of FIGS. 2A-2D, the control unit 322 of FIGS. 3A1, 3A2, and 3B, the control unit 622 of FIGS. 6A1, 6A2 and 6B, or combinations thereof. The optical level sensing devices 120(1)-(4) of FIG. 1 may implement the optical level-sensing device 1020 of FIGS. 10A and 10B, in some examples. The level-sensing device 1020 may include elements that have been previously described with respect to the level-sensing system 200 of FIGS. 2A-2D and or the in-tank portion 821 of the optical level-sensing device of FIGS. 8A-8C. Those elements have been identified in FIGS. 10A and 10B using the same reference numbers used in FIGS. 2A-2D and 8A-8C and operation of the common elements is as previously described. Consequently, a detailed description of the operation of these particular elements will not be repeated in the interest of brevity.

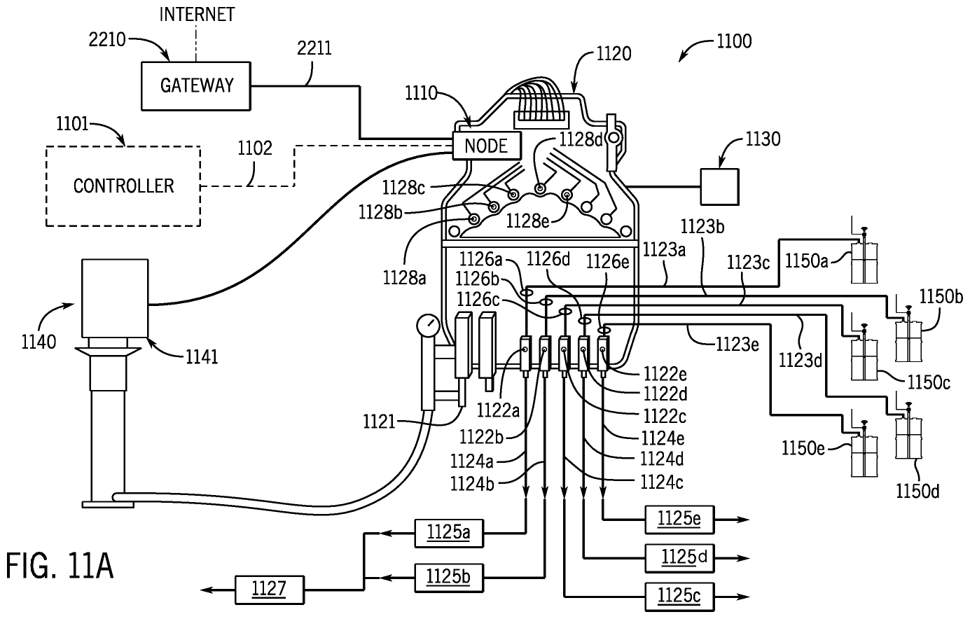

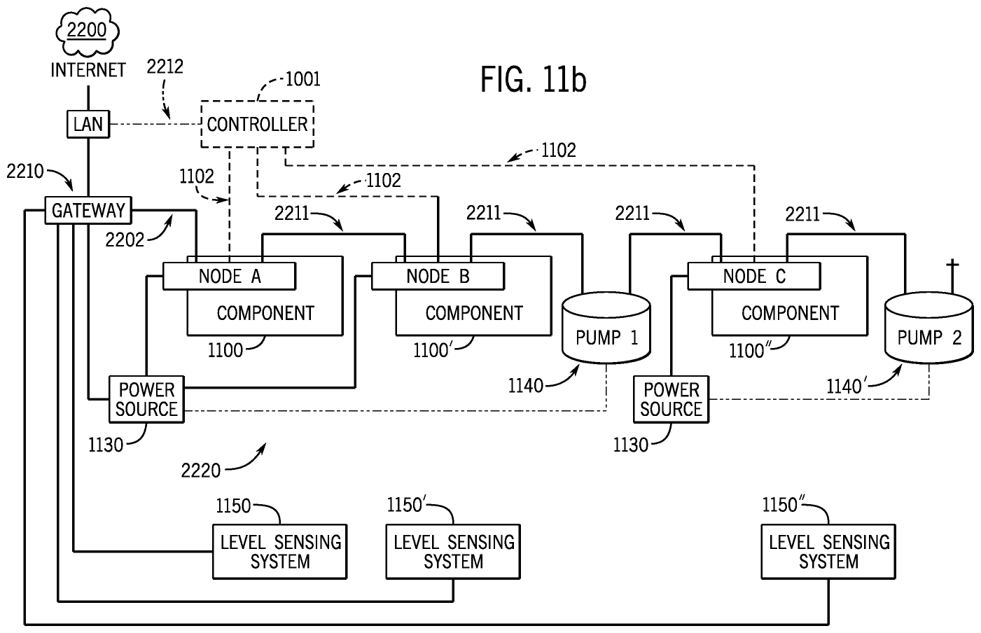

Turning to FIG. 11A, illustrated is a dilution control system 1100 that may be integrated with the level sensing system 100, according to the present disclosure. For example, in FIG. 11A, individual reservoir and level sensing systems 1150a-1150e are fluidly coupled to the solution delivery system 1120. More specifically, the solutions contained in the storage containers 110(1)-(4) may be fluidly coupled to the solution supply lines 1123a-1123e for use in distributing the solutions, e.g., as a mixed solution of chemical and water, via the dilution control system 1100. In some examples, as the level of solution changes in the storage containers 110(1)-(4), this information can be sensed by the level sensing system 100, and the sensed information may be transmitted to the dilution control system 1100. In such examples, the dilution control system 1100 may interpret the received information and may generate control signals based thereon.

With respect to the dilution control system 1100, this may include a processor 1110, a solution delivery system 1120 for mixing solutions (e.g., concentrated chemicals) with motive fluid to form one or more mixed solutions, and a power source 1130. The dilution control system 1100 may optionally include a pump 1140. Each of these may be housed within the same location where solutions are diluted in motive fluid (e.g., pumped water). As illustrated in FIG. 11A, the dilution control system 1100 may include the processor 1110 and solution delivery system 1120 integrated into a single assembly, and may include inputs for a connector 1102 (described herein), the power source 1130, and connection 1211 (described herein).

The dilution control system 1100 may be configured to monitor and control dilution operations by receiving signals from the processor 1110, from the optical level-sensing device and its control unit of the present disclosure, e.g., optical level-sensing devices 120(1)-(4), 220, 320, 1020 and their corresponding control units, from an optional external controller 1101, also referred to as a customary car wash controller, at the same location as the dilution control system 1100, or from combinations thereof. In response to receiving the signals, the processor 1110 of the dilution control system 1100 may interpret the signals and instruct the dilution control system 1100 to operate, such as by adjusting a rate of delivery of solutions from the solution delivery system 1120. The dilution control system 1100 may be operated via the processor 1110 and the power source 1130 of the dilution control system 1100, both of which may be separate from the optional external controller 1101 and the optical level-sensing device and any related components, e.g., separate from power and memory of such external devices. This may enable the processor 1110 to control when and if the dilution control system 1100 will operate upon receiving the signals from these external devices. Similarly, while the optical level-sensing device may transmit and receive information to the processor 1110 or other external devices, the control unit of the optical level-sensing device may control when and if the system will operate upon receiving signals from these external devices. For example, where the external controller 1101 might typically control some operations of the optical level-sensing device or a solution delivery system 1120, each of the presently disclosed optical level-sensing device (e.g., 120(1)-(4), 220, 320, 1020) and the dilution control system 1100 may instead control their respective operations by overriding signals sent by the external controller 1101. In this example, some components of the optical level-sensing device and/or the solution delivery system 1120 may be a legacy component of a pre-existing device or system operated by the external controller 1101, also known as a customary car wash controller of the legacy component.

According to the present disclosure, the processor 1110 of the dilution control system 1100 may use onboard memory and programming for controlling the dilution control system 1100. The processor 1110 may be communicatively coupled to the solution delivery system 1120, the power source 1130, the pump 1140, the optical level-sensing device (e.g. 120(1)-(4), 220, 320, 1020), the external controller 1101, as well as other system and network components of the present disclosure; and may be configured to send and receive signals to and from these communicatively coupled components. The processor 1110 may be configured, for instance, as a microcontroller or a computer processor depending processing requirements for operating the dilution control system 1100. The processor 1110 may generate control signals to, for instance, cause the power source 1130 to power on/off the dilution control system 1100 and cause the solution delivery system 1120 to cause solutions (e.g., concentrated chemicals) and motive fluid to be mixed according to a target dilution rate. In some cases, the processor 1110 may instruct the dilution control system 1100 to be powered at a voltage independent of a sensed voltage from the external controller 1101 such that the dilution control system 1110 is not capable of converting voltage received from the external controller 1101 into a different voltage for operation of electrical components coupled to the solution delivery system 1120. However, the dilution control system 1100 may include a voltage converter that takes a standard input (e.g., 24 VDC) for valve actuation and converts to a different voltage (e.g., 5 VDC) for the processor 1110, but such a converter may not be present at an interface between the dilution control system 1100 and the external controller 1101. The control units of the present disclosure (e.g., 222, 322, 622) may be configured the same as the processor 1110 described herein, for instance, to receive input from such external devices and generate its own control signals for operation of the optical-level sensing device.

The processor 1110 may be powered via a communications link, such as a link from network components at the setting housing the dilution control system 1100. For instance, the processor 110 may be coupled via a serial communication cable to a network component and may be powered therefrom. In addition or alternatively, the processor 1110 may be powered from another power source, for instance, depending upon the need for connection of sensors or actuators and their power demand. In some implementations, the processor 1110 is powered from the power source 1130.

The solution delivery system 1120 of the dilution control system 1100 may be configured to facilitate fluid distribution, e.g., solution, motive fluid and mixed solution distribution, and mixing of solution and motive fluid to form the mixed solution, in response to receiving control signals from the processor 1110. The solution delivery system 1120 may be configured with actuators that control valves, and the processor 1110 may be referred to as a valve node. The valve(s) may be coupled to one or more fluid chambers configured to mix a solution (e.g., a solution from the solution tank 110(1)-110(4) or other concentrated chemical) and water in a mixed solution in which the solution is diluted, and distribute the mixed solution. For instance, the dilution control system 1100 may include one or more solenoid valves, each operatively connected to a fluid chamber. By controlling an on/off status of the solenoid valve(s), fluid flow may be controlled through the fluid chamber(s). In FIG. 11A, upon operation of individual actuators such as solenoid valves 1128a-1128e, motive fluid from a motive fluid inlet 1121 of the solution delivery system 1120 may deliver motive fluid to corresponding motive fluid inlets of one or more fluid chambers 1122a-1122e fluidly coupled to solution supply lines 1123a-1123e via solution inlets of the fluid chambers 1122a-1122e, and the motive fluid may mix with each of the respective solutions in their respective fluid chambers 1122a-1122e. The mixed solutions may each exit a mixed solution outlet 1124a-1124e of each of the respective fluid chambers 1122a-1122e. The solution delivery system 1120 may be configured as a bank of valves and injectors in a dispensing panel that may be responsible for distributing mixed solutions from a plurality of fluid chambers coupled to the bank of actuators in response to receiving control signals from the processor 1110 of the dilution control system 1100. Injectors (such as venturi injectors, also known as eductors) may house the fluid chambers 1122a-1122e and may define the mixed solution outlets 1124a-1124e, which may lead to one or more application areas where the mixed solution is applied or where the mixed solution is further mixed with other motive fluid, solutions, or mixed solution(s).

In some implementations, the fluid chambers 1122a-1122e each may be coupled to individual solution supply lines 1123a-1123e via individual metering devices 1126a-126e. The individual solution supply lines 1123a-1123e may be fluidly coupled to a respective individual reservoir and level sensing system 1150a-1150e. The metering devices 1126a-1126e may include, for example, a solution inlet of a fluid chamber with an adjustable orifice supplying the solution to the solution inlet. The orifice opening may be adjusted to reach the target level of the solution. For example, the orifice may be widened or narrowed to permit more or less solution into the solution inlet of the fluid chamber to adjust a metering rate of the solution, such as using a pinch valve. In addition or alternatively, the metering devices 1126a-1126e may include a positive displacement pump such as a peristaltic pump that may positively displace fluid over an impingement path, and the rate of fluid displacement may be adjusted to increase or decrease a rate of solution delivery from the tube. Adjusting the rate of displacement may be through adjusting a rotation rate of one or more rollers of the peristaltic pump. Accordingly, in this example, the peristaltic pump may be configured to impinge on a solution delivery tube where a rate of displacement of the solution from the solution delivery tube may be adjusted to change a metering rate of the solution.

Chemical delivery systems that include actuators and eductors also known as venturi injectors are disclosed in U.S. Pat. No. 8,887,743 B2, the disclosure of which is incorporated herein by reference for any useful purpose. Chemical injectors may include a motive fluid inlet, a chemical inlet and a mixed solution outlet and may operate to draw in concentrated chemical (e.g., a solution from one or more storage containers) into a mixing chamber upon delivery of a motive fluid into the mixing chamber, which creates a vacuum pressure in the mixing chamber to thereby draw in the concentrated chemical(s). The metered amount of concentrated chemical drawn into the mixing chamber may be adjusted by adjusting a cross-sectional size of the flow path through which the chemical passes, which may adjust a flow rate of the chemical to thereby adjust a dilution rate. In addition or alternatively, the mixing chamber or chemical injector may receive concentrated chemical via a positive displacement pump. In some implementations, the motive fluid may be delivered via a common motive fluid supply, such as via a delivery manifold with a motive fluid inlet and a plurality of outlets each coupled to an injector. Manifolds for receiving and distributing motive fluid are also disclosed in U.S. Pat. No. 8,887,743 B2.

Implementations where a metering device is configured to adjust a cross-sectional size of the flow path through which the concentrated chemical passes and which may be coupled to the chemical delivery system 1120 at the solution inlets of the mixing chambers, injectors or other mixing devices, are disclosed in US 2019/0022607 A1, the disclosure of which is incorporated herein by reference for any useful purpose.

While the rate of distribution of solutions at the mixing devices, e.g., injectors, may be controlled by means such as controlling the size of a solution outlet port leading to the solution injector (e.g., including fluid chambers 1122a-1122e), controlling the size of the solution inlet port of the solution injector, controlling a metering rate of a pump, and so on, the intended or target rate of solution distribution may differ from the actual rate of distribution (e.g., due to the size of the outlet port being too large or too small for the intended rate of distribution) resulting in a mixed solution having a dilution rate that is off-target. Accordingly, the dilution control systems 1100 of the present disclosure optionally include one or more sensors for sensing tracer components optionally present in the mixed solution at or upon exiting the mixed solution outlet 1124a-1124e fluidly coupled to the fluid chamber 1122a-1122e. The optional tracer components may be components having detectable properties present in the solution supply, e.g., within the storage tanks 210, and may be pre-existing components of the solution or may be added thereto. These may be active or inactive components relative to the function of the solution. Once the mixed solution is formed and/or distributed from the mixed solution outlet, e.g., one or more of mixed solution outlets 1124a-1124e, and before the mixed solution is further mixed or applied to a target, a sensor such as sensors 1125a-1125e may sense a level of a tracer component in the mixed solution and may determine a dilution rate of the solution in the mixed solution, or the sensed information may be sent to the processor 1110 for determining the dilution rate.

As shown in FIG. 11A, the housings of each of the sensors 1125a-1125e may be coupled to fluid lines fluidly coupled to corresponding mixed solution outlets 1124a-1124e on a one-to-one basis such that each sensor may sense a tracer in the mixed solution of a mixture of a single solution with its tracer component and the motive fluid. The sensors 1125a-1125e may each be configured to sense one or more tracer components. For instance, the sensors 1125a-1125e may be configured to sense the same tracer component as the other sensors, or may be configured to sense a tracer component that differs from the tracer components sensed by other tracer components. In addition or alternatively, each of the sensors 1125a-1125e may be configured to sense different levels, e.g., discrete ranges, of the tracer component compared to the other sensors. In this way, solutions containing a specific tracer component or a specific level of tracer component may be fluidly coupled to the fluid chamber, e.g., 1122a-1122e, having the corresponding downstream sensor, e.g., 1125a-1125e, for sensing the tracer component or range of tracer component contained therein.

The sensors 1125a-1125e may be configured to sense properties such electrical conductivity, total dissolved solids (TDS), salinity, pH, dissolved oxygen, color, and the tracer component may be a corresponding component having such properties that are capable of being sensed by the sensor. Thus, the sensors 1125a-1125e may be electrical conductivity sensors, TDS sensors, salinity sensors, pH sensors, oxygen sensors, spectral analysis sensors, and combinations thereof.

Further, the sensors 1125a-125e may be communicatively coupled to the dilution control system 1100 such as the processor 1110, to a communications gateway 1210, or other networked components, and such communicative coupling may be wired or wireless according to the various communication modes disclosed herein.

Separate from the sensors 1125a-1125e, implementations may further include one or more additional sensors 1127 downstream of the sensors 1125a-1125e for use in sensing combinations of mixed solutions, such as a combination of mixed solutions from mixed solution outlets 124a and 124b. The one or more additional sensors 1127 may be configured to sense the same or a different tracer component from the tracer components sensed by sensors 1125a and 1125b. The additional sensors may be used to determine that the combination of mixed solutions is present in a target amount, and may be communicatively coupled to the dilution control system 1100 in the same manner as the sensors 1125a-1125e to enable the dilution control system 1100 to adjust a level of one or more of the solutions dispensed in the combined mixed solution.

While the dilution control system 1100 may adjust the metering device and/or the motive fluid delivery rate to reach a target dilution rate for later produced mixed solutions, the dilution control system 1100 may be further configured to manipulate the dilution of existing analyzed mixed solutions to reach a target dilution rate. For instance, water may be added to the existing and analyzed mixed solutions when under-diluted, or by adding solution or a more concentrated mixed solutions when over-diluted. This approach may enable the dilution of an existing amount of the mixed solution, e.g., a batch of the mixed solution, to be adjusted to reach a target dilution rate before being delivered to downstream locations.

Further details of the dilution control system 1100 are disclosed in U.S. patent application Ser. No. 17/976,147, filed on Oct. 28, 2022 and entitled “SYSTEMS AND METHODS FOR MONITORING AND CONTROLLING DILUTION RATES”, the disclosure of which is incorporated herein by reference for any useful purpose.

The solution delivery system 1120 may be configured to additionally include: pumps, motors (e.g., stepper motors), sensors (e.g., thermometers, cameras), heating elements, servo actuators, or another actuator that requires electric control.

In certain implementations, the processor 1110 may receive signals from the dilution control system 1100, e.g., indicating an operational status the solution delivery system 1120, the sensors 1125a-1125e, as well as signals and information from other communicatively coupled components such as other dilution control systems (e.g., 1100′), actuators, motors, variable frequency drives, pumps and valves, sensors, a communications gateway with in the setting housing the dilution control system 1100, and from network components outside of the setting housing the dilution control system 1100, for use in controlling the solution delivery system 1120. For instance, the processor 1110 may be programmed to sense or receive information about power to the overall system, power to the dilution control system 1100, connectivity to a network, the number of operations of the dilution control system 1100 (e.g., dispensing events, timing of dispensing events), solution (e.g., concentrated chemical) supply levels, dilution level, chemical conductivity, pH of a mixed solution, pH of a chemical, pH of water, temperature of the water, temperature of the solutions, ambient temperature, humidity, target to be treated, the location of the dilution control system (e.g., GPS components or arrangement within a setting), age, wear, or operational status, and a network identifier.

In one example, the number of cycles or duration a dilution control system 1100 has been in use may be determined by the processor 1110 and may provide reporting to the network components based thereon. The processor 1110 may be programmed to generate different control signals for operating the dilution control system 1100 using the gathered information. The processor 1110 may instruct motors or pumps to be powered on for a longer duration as the dilution control system 1100 ages in order to reduce wear on the component from frequent on/off cycles. Other examples may involve the processor 1110 generating control signals to adjust pump pressure, solution use, dilution ratios, and so on.

In some implementations, the solution delivery system 1120 may operate by a single control voltage, which may be 24 VDC, provided by the power source 1130. However, the solution delivery system 1120 may be configured to accept any common control voltage, e.g., 24 VAC, 24 VDC, or 120 VAC, ±20%, and so on, from the power source 1130. The power source 1130 may be integrated into the dilution control system 1100 or may be arranged separately within the confines location where the dilution control system 1100 is situated and may be configured as a breaker box or a battery, for example. The power source 1130 may be independent of any power source of the external controller 101, which provides autonomy to the dilution control system 1100.

An optional pump 1140 of the dilution control system 1100 may provide fluid pressure to the dilution control system 1100. The pump 1140 may be communicatively coupled to the processor 1110 and the power source 1130 and may be configured to deliver fluid pressure to operate the solution delivery system 1120 such as by pressurizing motive fluid for delivery to the solution delivery system, which pressurized motive fluid may enter via the fluid inlet 1121 or be pressurized by the pump 1140 at the fluid inlet 1121. For instance, upon receipt of power from the power source 1130 in response control signals from the processor 1110, the pump 1140 may deliver fluid pressure over a pre-determined timing cycle to a fluid input line of the solution delivery system 1120. The pump 1140 may provide water pressure to the dilution control system 1100, which may provide pressure assistance to a water supply, e.g., a municipal water supply, or may provide the sole source of pressure to the water input of the dilution control system 1100 and for instance may be responsible for delivering motive fluid to the motive fluid inlet 1121 of the solution delivery system 1120.

The pump 1140 may also provide pressure to a solution input of the dilution control system 1100, however, the solution input may alternatively rely on vacuum pressure for fluid delivery into the dilution control system 1100, for instance using venturi valves, which are disclosed in U.S. Pat. No. 8,887,743 B2. The pump 1140 may include a processor 1141 communicatively coupled to the processor 1110 of the dilution control system 1100 and operation of the pump 1140 may be controlled through communications between the processors 1110, 1141. As can be appreciated, in some implementations, the pump 1140 may be a dilution control system 1100 that cooperates with other dilution control systems, e.g., a second dilution control system 1100′, as described.

In some implementations, the processor 1110, the solution delivery system 1120, the power source 1130, and/or the pump 1140 may be housed within the dilution control system 1100, and may be integrated into the same dispensing panel. In a further example, the processor 1110 may be wired or wirelessly coupled to the dilution control system 1100. For instance, the processor 110 may be wired to multiple, individual actuators, all of which may be housed within a dispensing panel.

According to implementations of the present disclosure where an external controller 1101 controls distribution of solutions to the solution delivery system 1120 or where the external controller 1101 controls the solution delivery system 1120, the processor 1110 may receive a sensed voltage from the external controller 1101 to cause a level of solution to be delivered at a pre-determined setting to reach a target dilution rate, and the processor 1110 may instruct the solution delivery system 1120 of the dilution control system 1100 to be powered via the power source 1130 at a voltage independent of the sensed voltage. Where the actual dilution rate sensed by the sensor, e.g., sensor 1125a-1125e, differs from the target dilution rate, the processor 1110 of the dilution control system 1100 may override the external controller 1101 and cause the power source 1130 to operate the solution delivery system 1120 such that a level of the solution dispensed from the solution delivery system 1120 is adjusted, e.g., increased or decreased, to reach the target dilution level.

In such implementations where the dilution control system 1100 operates in combination with a customary external controller 1101, the external controller 1101 may be a customary power source that delivers timed voltage signals to multiple systems in the setting where the dilution control system 1100 is arranged, including solution delivery systems, and may typically deliver common control voltages of: 24 VAC, 24 VDC, or 120 VAC, ±20% to operate these multiple systems, including fluid management and dilution systems. However, the processor 1110 of the dilution control system 1100 may instead interpret the control voltage of the external controller 1101 simply as a signal (e.g., a sensed voltage), and instead of allowing the same signal to be relayed to the solution delivery system 1120 of the dilution control system 1100, the processor 1110 may interpret the signal (e.g., as a signal meant to perform some action or operation by the dilution control system 100), generate a different control signal and send this to the solution delivery system 1120 for dispensing solutions according to the commands of the dilution control system 1100. Thus, while the external controller 1101 may control the operation of other devices in this setting, the external controller 1101 may more simply deliver a signal to the dilution control system 1100 for subsequent interpretation by the processor 1110 and action. This configuration may provide the dilution control system 1100 autonomy relative to other devices that may be controlled in a customary manner by the external controller 1101. For instance, the external controller 1101 may be responsible for controlling air, water, solution dispensing, and/or coordinating other aspects related to fluid management and delivery by using programmable logic controller (PLC) or similar technology and may send signals to various components in the setting. These signals might be control voltages, analog signals, or digital signals. While the external controller 1101 may control a variety of different devices, the dilution control systems 1100 of the present disclosure are responsible for orchestrating their own operation due to their ability to interpret control signals received from the external controller 1101 and generate new control signals for operation of the dilution control system. A number of components may be controlled by the external controller 1101, while dilution control systems (e.g., 1100, 1100′, 1100″) provided according to the present disclosure, may operate independently from the external controller's 1101 commands.

In implementations where the processor 1110 is programmed to generate a separate signal from the external controller 1101, the dilution control system 1100 may be operated using different operating parameters relative to the parameters sent by the external controller 1101. The processor 1110 may be configured to receive control signals from the external controller 1101 and/or from the communications gateway 1210, and/or from other processors 1110 of other dilution control systems described herein, and based on a variety of information collected by the processor 1110, the processor may generate a new control signal and send to the solution delivery system 1120 of its dilution control system 1100 in a dedicated manner. For instance, the processor 1110 may be programmed to track operations of the dilution control system 1100 and generate control signals for operation of the dilution control system 1100 based thereon. The processor 1110 may query its communicatively coupled components for information that can affect the operating parameters of the dilution control system 1100 and may be used by the processor 1110 to configure the control signal using the received information. In some implementations, the processor 1110 may be configured to only receive commands from the external controller 1101 and/or the communications gateway 2210, and/or from other processors of other dilution control systems, but may not be configured to send instructions to these components.

Turning to FIG. 11B, the dilution control system 1100 that may be integrated with the level sensing systems 1150, 1150′, 1150″, according to embodiments of the present disclosure. The control units of the level sensing systems 1150, 1150′, 1150″ may be communicatively coupled with the dilution control system 1100, also referred to as a component 1100 and a number of components 1100, 1100′, 1100″, and these systems be may be communicatively coupled to a local communications gateway 2210 for use in facilitating fluid delivery operations in a fluid delivery control system 2220 with other components 1100′, 1100″ of the fluid delivery control system 2220. The components 1100′, 1100″ may for example be configured as dilution control systems including the components of the dilution control system 1100, as described, and/or as solenoid valves, pressure gauges, pumps, motors, sensors, heating elements, servo actuators, other actuators, and so on. The components 1100′, 1100″ may be fluidly coupled to a respective level sensing system 1150′, 1150″. As shown in FIG. 11B, the power source 1130 may provide power to the components of the fluid delivery control system 2220 and/or to the level sensing systems 1150, 1150′, 1150″ and optionally pumps 1140; however, the power source 1130 may be separate from any power source derived from the optional external controller 1101 to allow for the independent operation of the components of the fluid delivery control system 2220.

The communications gateway 2210 may be configured with a processor and be communicatively coupled to the level sensing systems 1150, 1150′, 1150″ and/or system components 1100, 1100′, 1100″ via connection 2211 (e.g., a serial connection) and the external controller 1101 via connection 2212. Each fluid delivery control system 2220 may include its own communications gateway 2210 and the gateway 2210 may be coupled to remote locations via the internet, as well as to other devices at the fluid delivery control system 2220 via the internet via a local area network (LAN) or other near range communication equivalents, e.g., Wi-Fi, Bluetooth or LoRa, RFID, NFC, ANT, Zigbee, or WLAN, or via long range communication equivalents such as WAN. The communications gateway 2210 may troubleshoot or fix problems with the components 1100, 1100′, 1100″, 1150, 1150′, 1150″ and may send programming updates to processors of these components (e.g., processor 1110 or control units), for example.

Where multiple components (e.g., 1100, 1100′, 1100″, 1150, 1150′, 1150″) are used in one fluid delivery control system 2220, the components may operate independently of one another. In addition or alternatively, the dilution control system 1100 may receive information about itself, e.g., over-dilution or under-dilution such as due to a worn out or occluded metering device nozzle, and sends this information to the gateway 2210 for taking action. For instance, the gateway 2210 may instruct a second component 1100′ to deliver a mixed solution therefrom so as to compensate for the problems at the dilution control system 1100. In addition, the processor 1110 of the dilution control system 1100 may send information to the communications gateway 2210 indicating that the dilution control system 1100 requires maintenance or service. In addition or alternatively, the components (e.g., 1100, 1100′, 1100″, 1150, 1150′, 1150″) may communicate directly with each other for assisting or controlling operation of their respective electrical components, e.g., solution delivery system 1120 or control valves. In this example, the processors or control units of the respective components 1100, 1100′, 1100″, 1150, 1150′, 1150″ may be configured to communicate with one another, for instance using the disclosed near range communication technologies, and one or more of the processors may send control signals to the other component for subsequent interpretation and generation of a control signal as described herein.

Some components may be responsible for sensing conditions that may impact operating parameters of the level sensing system 1150 or the dilution control system 1100 (e.g., water usage, solution usage, water temperature), while others may use the sensed information to dynamically adjust the operation of the level sensing system 1150 (e.g., to adjust a metering rate or send an alert about a state of level sensing system) or the dilution control system 1100 (e.g., to decrease water, increase solution, deliver cold water) or to determine whether the component operates at all. Accordingly, examples of communicative coupling between the communications gateway 2210 and components 1100, 1100′, 1100″, 1150, 1150′, 1150″ may include providing sensed information such as temperature, humidity, pH level, solution supply level, dilution level, or soil level, soil type, age, wear, or operational status, from one component to the gateway 2210. The gateway 2210 may interpret the information, and generate control signals for operation of one or more of the components 1100, 1100′, 1100″, 1150, 1150′, 1150″. For instance, the processor 1110 of the second component 1100′ may sense temperature information regarding ambient temperatures, water temperatures, solution temperatures, and/or mixed solution temperatures, and may transmit this sensed information to the gateway 2210 for use in adjusting the operating parameters of the dilution control system 1100 or the level sensing system 1150′, such as to adjust the temperature of the motive fluid or increase or decrease an amount of solution used in the mixed solution. In addition or alternatively, the communications gateway 2210 may serve as a communications relay between the components without interpreting the information, and the processor 1110 of the dilution control system 1100 or the control unit of the level sensing system 1150 may interpret the received information and generate a control signal accordingly.

In FIG. 11B, the external controller 1101 may optionally be coupled to the dilution control system 1100 as well as other components 1100′, 1100″, each via connection 1102, which may be a multi-conductor cable often called a “home run cable”. The components 1100, 1100′ and 1100″ of the fluid delivery control system 2220 may each be coupled to the communications gateway 2210 via a serial connection 2211, such as a MODBUS RTU serial connection. The communications gateway 2210 may be directly coupled to the external controller 1101 via coupling 2212, such as local area network (LAN) connection. The components 1100, 1100′, 1100″ may operate independently of one another as described herein, and optionally may operate in concert with one another, for example, by way of the communications gateway 2210 and the serial connection 2211. In some implementations, the components 1100, 1100′, 1100″ may be communicatively coupled via peer-to-peer connections such as near range communications including Wi-Fi, Bluetooth or LoRa, RFID, NFC, ANT, Zigbee, or WLAN or via long range communication equivalents such as WAN.

Multiple communications gateways 2210 may be connected to a network 2200 over the internet. Local network connections between the components 1100, 1100′, 1100″ and the communications gateways 2210 may include but are not limited to serial connection such as RS485 connections, Ethernet/LAN, Wi-Fi, Bluetooth, mobile data connections, and expandable connections.

In some implementations, the network 2200 may transmit information to a user interface related to connectivity, usage, diagnostics, and so on for the dilution control system 1100 at the various fluid delivery control systems 2220 having a respective communications gateway 2210. The user interface may be delivered through a web application. The user interface may be graphically configured to include information about each of the components 1100, 1100′, 1100″ at a given fluid delivery control system 2220, along with operating parameters such as: solution name, injector used, dilution setting, sensed tracer or dilution levels, alert settings, sensor connectivity, etc. The graphical interface may enable the user to set alerts and configure parameters such as dilution settings.

In some implementations, a user may transmit information to the network 2200 via the user interface, and for instance, may make product orders or request service calls for addressing problems at the various fluid delivery control systems 2220. Due to the ability of the communications gateway 2210 to provide information about individual components 1100, 1100′, 1100″, each having their own unique ID, product orders may identify a specific component where the order is to be delivered and used.

The network 2200 may receive periodic updates from the communications gateway 2210, such as weekly, and the network 2200 may be configured to aggregate this information for reporting. Critical conditions such as inventory levels and key maintenance events may be sent more frequently to the network 2200. In addition or alternatively, the network 2200 and/or the communications gateway 2210 may be communicatively coupled to bar code readers, automatic inventory reconciliation, in bay applicators, custom solution containers, maintenance logs and so on. The network 2200 may use collected information for reporting, advanced analytics and predictive statistics (e.g., based on environmental factors).

The disclosed embodiments may be combined with the features of the sensing and control systems and methods of the disclosure of U.S. Publication No. US 2021/0349482 A1 is incorporated herein by reference for any useful purpose.

Implementations consistent with the present disclosure are as follows:

An optical chemical level-sensing arrangement may include a storage container configured to store a liquid chemical solution with an opening in a top surface, a float device including a target surface, an elongated tube installed through the opening in the storage container and extending from a bottom of the storage container to the top surface of the storage container, where the elongated tube is configured to retain the float device with the target surface facing toward a top of the storage container, and where the float device is configured to move vertically within the elongated tube in response to changes in a level of the liquid chemical solution within the storage container, and a flange configured to attach to the opening on the top side of the storage container and configured to connected to a top end of the elongated tube, where the flange is configured to receive a sealed control unit having an optical time-of-flight sensor measure a return time of reflections of the optical signals off of the target surface of the float device to determine a level of the liquid chemical solution within the storage container.

Another optical chemical level-sensing device may be configured to couple to the storage container of the preceding optical chemical level-sensing arrangement. The device may include a sealed control unit configured to connect to a flange protruding from a top of the storage container and may include an optical time-of-flight sensor and a lens. When connected to the flange, the lens is configured to provide a physical barrier between a liquid chemical solution in the storage container and the optical time-of-flight sensor, while also allowing optical signals to pass through, and where the optical time-of-flight sensor is configured to emit optical signals through the lens toward a target surface of a float device housed in an elongated tube connected to the flange and to measure a return time of reflections of the optical signals off of the target surface to determine a level of the liquid chemical solution within the storage container.

A fluid delivery system may include a solution supply, a level sensing system, and a metering device fluidly coupled to the solution supply, where the metering device is communicatively coupled to the level sensing system. The level sensing system may include a sealed control unit configured to connect to a flange protruding from a top of an elongated tube or flange protruding from a top of a storage container having the solution supply and including an optical time-of-flight sensor and a lens, and when connected to the top of the elongated tube or the flange, the lens is configured to provide a physical barrier between the solution supply in the storage container and the optical time-of-flight sensor, while also allowing optical signals to pass through. The optical time-of-flight sensor is configured to emit optical signals through the lens toward a target surface of a float device housed in the elongated tube and to measure a return time of reflections of the optical signals off of the target surface to determine a level of the liquid chemical solution within the storage container.

Various changes may be made in the form, construction and arrangement of the components of the present disclosure without departing from the disclosed subject matter or without sacrificing all of its material advantages. The form described is merely explanatory, and it is the intention of the following claims to encompass and include such changes. Moreover, while the present disclosure has been described with reference to various embodiments, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. An optical chemical level-sensing device, comprising:
an elongated tube including a length greater than a height of a storage container configured to store a liquid chemical solution, wherein, during installation, the elongated tube is configured to be inserted into a hole in a top of the storage container until a bottom end rests at or near a bottom portion of the storage container with a portion of the elongated tube extending above the top of the storage container, wherein the bottom end of the elongated tube is configured to allow liquid to flow into and out of the elongated tube while installed in the storage container such that a level of the liquid chemical solution within the elongated tube corresponds to a level of the liquid chemical solution in the storage container;
a float device configured to be inserted into the elongated tube and to move vertically within the elongated tube in response to changes in the level of the liquid chemical solution, wherein the float device includes a target surface facing toward the top of the storage container and vertically-positioned at a height within the elongated tube equal to or slightly above the level of the liquid chemical solution within the elongated tube, wherein the target surface is configured to reflect optical signals; and
a sealed control unit configured to be positioned on a top end of the elongated tube, wherein the sealed control unit comprises an optical time-of-flight sensor and a lens, wherein the lens is configured to provide a physical barrier between the liquid chemical solution and the optical time-of-flight sensor, while also allowing the optical signals to pass through, wherein the optical time-of-flight sensor is configured to emit optical signals through the lens toward the target surface of the float device and to measure a return time of reflections of the optical signals off of the target surface to determine the level of the liquid chemical solution within the storage container.

2. The optical chemical level-sensing device of claim 1, wherein the target surface includes a shape defined by a top face of the float device.

3. The optical chemical level-sensing device of claim 2, wherein the float device includes a body portion extending between the target surface and a base, wherein the base defines a star shape and a diameter of the body portion is smaller than the target surface and the base.

4. The optical chemical level-sensing device of claim 2, wherein the float device includes an outer portion adjacent the target surface having external ribs configured to interleave with elongated grooves formed vertically in inner sidewalls of the elongated tube to control rotation of the float device as it moves within the elongated tube.

5. The optical chemical level-sensing device of claim 1, wherein the sealed control unit further includes a processor configured to communicate with the optical time-of-flight sensor to receive time-of-flight data and to determine the level of the liquid chemical solution within the storage container based on the time-of-flight data.

6. The optical chemical level-sensing device of claim 5, wherein the processor is further configured to wirelessly communicate the level of the liquid chemical solution to an external computing device.

7. The optical chemical level-sensing device of claim 5, wherein the processor is further configured to adjust the determined level of the liquid chemical solution based on an orientation of the optical time-of-flight sensor relative to the surface of the liquid chemical solution in the storage container.

8. The optical chemical level-sensing device of claim 7, wherein the sealed control unit further includes a position sensor configured to detect the orientation of the optical time-of-flight sensor relative to the surface of the liquid chemical solution in the storage container.

9. The optical chemical level-sensing device of claim 1, wherein the optical time-of-flight sensor includes a light detection and ranging (LiDAR) sensor.

10. The optical chemical level-sensing device of claim 1, wherein the float device includes a splined device with sidewalls including vertical ribs and grooves.

11. A chemical level sensing system, comprising:
a processor;
an optical time-of-flight sensor communicatively coupled to the processor;
a control unit containing at least the sensor, the control unit comprising a protective lens, wherein the sensor is arranged behind the lens such that the sensor is protected within an interior of the control unit;
an elongated tube coupled to the control unit and configured to be inserted vertically through an opening in a storage container; and
a float device arranged in the elongated tube and configured to be movable,
wherein the sensor is configured to transmit signals through the lens to sense a distance between the sensor and the float arranged in the elongated tube when the elongated tube is arranged in the storage container containing a liquid chemical solution, wherein a bottom end of the elongated tube is configured to allow liquid ingress and egress while installed in the storage container such that a level of the liquid chemical solution within the elongated tube corresponds to a level of the liquid chemical solution in the storage container, and
wherein based on a sensed distance between the sensor and the float, the processor is configured to calculate a level of the liquid chemical solution present in the storage container.

12. The chemical level-sensing system of claim 11, wherein the processor is further configured to adjust the calculated level of the liquid chemical solution present in the storage container based on an orientation of the optical time-of-flight sensor relative to a surface of the liquid chemical solution within the storage container.

13. A solution delivery system comprising the chemical level sensing system of claim 11 and a dilution control system, wherein the dilution control system integrates the processor of the chemical level sensing system into a single assembly.

14. A chemical level sensing system, comprising:
a control unit containing a processor and an optical time-of-flight sensor communicatively coupled to the processor, the control unit comprising a protective lens, wherein the sensor is arranged behind the lens such that the sensor is protected within an interior of the control unit;
an elongated tube coupled to the control unit and configured to be inserted vertically through an opening in a storage container; and
a float arranged in the elongated tube and configured to be movable,
wherein the sensor configured to transmit signals through the lens to sense a distance between the sensor and the float arranged in the elongated tube when the elongated tube is arranged in the storage container containing a chemical solution undergoing egress therefrom such that a level of the liquid chemical solution within the elongated tube corresponds to a level of a liquid chemical solution in the storage container, and
wherein based on a sensed distance between the sensor and the float, the processor is configured to calculate a level of a chemical present in the storage container during such egress.

15. The chemical level sensing system of claim 14, wherein the processor or another processor of the chemical level sensing system causes a rate of the egress of the liquid chemical solution to be adjusted based on a target level of chemical delivery.

16. The chemical level sensing system of claim 14, further comprising an end cap installed at a lower end of the elongated tube, wherein the end cap is configured to block the float from leaving the tube while allowing the liquid chemical solution to enter and exit the tube.

17. The chemical level sensing system of claim 14, wherein the processor or another processor is communicatively coupled to a metering device configured to adjust the rate of egress of the chemical, the metering device comprising a chemical inlet of an eductor configured to receive the chemical and a motive fluid in a mixing chamber thereof, and wherein a size of an orifice supplying the chemical to the chemical inlet is adjusted to reach a target level of chemical delivery.

18. The chemical level sensing system of claim 14, wherein the processor or another processor is communicatively coupled to a metering device configured as a positive displacement pump, the positive displacement pump configured to impinge on a chemical delivery tube of the metering device, and wherein a rate of displacement of the chemical from the chemical delivery tube is adjusted to reach the target level chemical delivery.

19. A solution delivery system comprising the chemical level sensing system of claim 14.
